(19) United States
(12) Patent Application Publication
(10) Pub. No.: US 2009/0117876 A1
(43) Pub. Date: May 7, 2009

(54) COMMUNICATION SYSTEM, COMMUNICATION METHOD, AUTHENTICATION INFORMATION MANAGING SERVER, AND SMALL BASE STATION

(76) Inventor: TETSUO INOUE, Tokyo (JP)

Correspondence Address: NEC CORPORATION OF AMERICA, 6535 N. STATE HWY 161, IRVING, TX, 75039, US

(21) Appl. No.: 12/256,622

(22) Filed: Oct. 23, 2008

(30) Foreign Application Priority Data
Oct. 24, 2007 (JP) 2007-276543

(51) Int. Cl. H04W 12/06

(52) U.S. Cl. 455/411

(57) ABSTRACT

A communication system includes first authentication processing means, provided in a small base station, for acquiring first authentication information from a line switching communication terminal and transmitting the first authentication information to second authentication information processing means, ciphering key information acquiring means, provided in the second authentication information processing means, for acquiring ciphering key information on the line switching communication terminal from the first authentication information processing means based on first authentication information obtained from the small base station, authentication information mapping means, provided in the second authentication information processing means, for mapping the ciphering key information to second authentication information, mapping information transmitting means, provided in the second authentication information processing means, for transmitting the mapped information to the small base station, and ciphering key information extracting means, provided in the small base station, for extracting the ciphering key information from the mapped information.

This application is based upon and claims the benefit of priority from Japanese patent application No. 2007-276543, filed on Oct. 24, 2007, the disclosure of which is incorporated herein in its entirety by reference.

### BACKGROUND OF THE INVENTION

1. Field of the Invention

The present invention relates to a communication system, a communication method, an authentication information managing server, and a small base station, and in particular, to a communication system, a communication method, an authentication information managing server, and a small base station wherein second generation CAVE (Cellular Authentication and Voice Encryption algorithm) authentication information is mapped to IMS-AKA (IMS Authentication and Key Agreement) authentication information defined for an MMD (Multi Media Domain) network.

2. Description of the Related Art

FIG. 1 is a diagram of a configuration of an example of a communication system relating to the present invention. As illustrated in FIG. 1, the example of the related communication system includes 3GPP (3rd Generation Partnership Project) WCDMA (Wideband Code Division Multiple Access) and 3GPP2 CDMA2000 mobile network 101, fixed network 102, and communication network, for example, Internet 104.

Mobile network 101 includes 2G (Second Generation) mobile machine 111 based on an old authentication scheme, 3G (Third Generation) mobile machine 112 based on the old authentication scheme, 3G line and packet switching mobile machine 113 based on a new authentication scheme, line switching network 114, packet switching network 115, IMS (IP Multimedia Subsystem) and MMD (Multi Media Domain) network 116, and very small base station 117.

Fixed network 102 includes mobile machine 121 based on the old authentication scheme, fixed IP (Internet Protocol) telephone or PC (Personal Computer) 122, communication network 123 such as a fixed VoIP (Voice over Internet Protocol) network, a PWLAN (Public Wireless Local Area Network) network, or a CATV (Community Antenna Television) network, and very small base station 124.

Two communication networks 101 and 102 are connected together via Internet 104.

2G mobile machine 111 in mobile network 101 is connected to IMS and MMD network 116 via very small base station 117 and line switching network 114. 3G mobile machine 112 is similarly connected to IMS and MMD network 116 via very small base station 117 and line switching network 114. 3G line and packet switching mobile machine 113 is connected to IMS and MMD network 116 via line switching network 114 and packet switching network 115.

Mobile machine 121 in fixed network 102 is connected to Internet 104 via very small base station 124. Internet 104 is connected to IMS and MMD network 116. Fixed IP telephone or PC 122 is connected to communication network 123.

As regards technical developments, the market for mobile communication, which has developed rapidly, is shifting from a second generation (2G), which now dominates the market, to a third generation.

For the third generation mobile communication network, standard specifications have been formulated as a 3G Partnership Project (3GPP) in which carriers or venders or standards setting bodies from many countries participate. The standard specifications have been proposed to ITU (International Telecommunication Union) and fed back to the standards setting bodies in many countries.

The formulation of the specifications for the third generation mobile communication network globally involves schemes relating to roughly two bodies and a wireless segment.

One of the schemes is a 3GPP WCDMA scheme, which has been developed from GSM (Global System for Mobile communication) specifications. The other is a 3GPP2 CDMA2000 scheme, which was been adopted in several Asian countries including Japan, China, and South Korea.

In Japan, some carriers have adopted the WCDMA scheme, while others have adopted the CDMA2000 scheme.

For both WCDMA and CDMA2000, roughly two types of specifications have been formulated, according to applications, for a base station that processes signals in the wireless segment and for a configuration of a network for the base station.

One of the two types of specifications is for line switching. The other is for packet switching.

The specifications for both schemes have been formulated so as to ensure backward compatibility supporting second generation mobile machines.

3GPP in Europe, which has long focused on formulation of specifications for the third generation, has established specifications for a new subsystem that realizes multimedia service (voice, video, data exchange, and the like) including VoIP service accessible to a packet switching network.

In 3GPP, this subsystem is named IMS. IMS is intended to implement common multimedia service independent of specifications for an access network.

Based on an idea similar to that of 3GPP, 3GPP2 has been improving many of the IMS specifications so that the specifications are compatible with the 3GPP2 packet switching network. In 3GPP2, the improved specifications are named MMD.

Not only mobile communication business but also fixed telecommunication business pays attention to the IMS and MMD specifications because of a basic concept common to these specifications, the “implementation of common multimedia service independent of the specifications for the access network”. Mobile communication providers, in co-operation with related providers, carriers, and standards setting bodies for the fixed telecommunication business, are to start to formulate common IMS specifications for the next generation, as a subsystem serving as a core next-generation network (NGN). The 3GPP standards bodies name the specifications Common IMS.

Under these circumstances, a very small 3G base station (what is called a Femto Cell) with a relatively narrow radio wave coverage has emerged. Although standard specifications for the Femto Cell have not been formulated, mobile network carriers are examining the utilization of the Femto Cell in order to support integrated service (FMC) for fixed and mobile machines and to deal with zones blind to 3G radio waves.

Furthermore, in connection with 3GPP/3GPP2 standardization operations, an architecture has been discussed which enables multimedia communication to be performed by second generation mobile machines, which now dominate the market, and old 3G mobile machines, which belong to the third generation but have only the line switching function. Development of the architecture may be associated with the standardization of the Femto Cell.

Now, three communication systems will be discussed on which the present invention is based and which shift from existing line and packet switching services to multimedia service.

FIGS. 2a to 2c are diagrams of the three communication systems that shift from the existing line and packet switching services to the multimedia service. FIG. 2a illustrates the use of a mobile machine with a first MMD function. FIG. 2b illustrates the use of a mobile machine with a second MMD function. FIG. 2c illustrates the use of an existing mobile machine.

First, the use of the mobile machine having the first MMD function in FIG. 2a will be described.

According to this scheme, the multimedia service is implemented on mobile machine 141 in which card module ISIM (IMS Subscriber Identification Module) 131 is mounted and which has a control section that recognizes an MMD SIP (Session Initiation Protocol) signal controlling the multimedia service. A authentication control dedicated to the multimedia service can be performed on the card module ISIM, and the card module ISIM can be installed in and removed from the mobile machine.

According to this scheme, only IMS-AKA (IMS Authentication and Key Agreement) authentication information is used for access control in an MMD network by mobile machine 141 and all MMD network devices.

Next, the use of the mobile machine having the second MMD function in FIG. 2b will be described.

According to this scheme, the multimedia service is implemented on mobile machine 142 in which R-UIM (Removal User Identification Module) 133 is mounted and which has control section 134 recognizing the MMD SIP signal controlling the multimedia service. Existing, old CAVE (Cellular Authentication and Voice Encryption algorithm) authentication control can be performed on R-UIM 133.

According to this scheme, old CAVE authentication information transferred between control section 134 of mobile machine 142 and R-UIM 133 needs to be exchanged with IMS-AKA authentication information for an MMD layer which is transferred between control section 134 and a network using an SIP signal on a radio wave.

Next, the use of the existing mobile machine in FIG. 2c will be described. According to this scheme, the multimedia service is implemented, via small base station (Femto Cell) 144, on existing mobile machine 143 now used by a majority of CDMA2000 mobile communication users and having no multimedia service function such as the one described above.

According to this scheme, the old CAVE authentication information transferred between Femto Cell 144 and mobile machine 143 on the radio wave needs to be exchanged with the IMS-AKA authentication information for the MMD layer which is transferred between Femto Cell 144 and the network through the SIP signal.

The present invention is based on the use of the existing mobile machine in FIG. 2c.

Next, an IMS-AKA authentication sequence (see FIG. 2a) specified for the MMD network on which the present invention is based will be described.

IMS-AKA authentication is implemented by transmitting a random number (RAND-aka) for an authentication vector AV and a token (AUTN) for each user generated by an AuC in the MMD network, to authentication card module ISIM 131 mounted in mobile machine 141 as an authentication challenge, by returning an authentication response (RES) from the ISIM to the MMD network, and by comparing the response with an expected response value (XRES) for the authentication vector AV.

An S-CSCF, which shares, via an HSS, the authentication vector AV generated by the AuC, actually performs the comparison with the authentication response value.

When the IMS-AKA authentication succeeds, a server S-CSCF and a server P-CSCF on the network side share information on an IPSec matching key (IK) and a ciphering key (CK) which is an information element of the authentication vector AV. The P-CSCF and the mobile machine subsequently use the keys to establish an IPSec SA (Security Association).

This allows control of accesses to the MMD to be performed and makes communication between the P-CSCF and mobile machine 141 securer.

FIG. 3 is a sequence diagram illustrating an example of the IMS-AKA authentication sequence for a related communication system. A specific flow of signals in the IMS-AKA authentication is as follows.

For example, mobile machine 141 is powered on, and a user logs into an MMD service. Then, MMD control section 132 of mobile machine 141 transmits a SIP:REGISTER signal specified for the MMD to P-CSCF 151 (step S1). The signal contains no authentication information, or authentication this is calculated and based on old information is set in the signal.

Then, P-CSCF 151 selects appropriate S-CSCF 152 according to a scheme specified for the MMD. P-CSCF 151 transmits the SIP:REGISTER signal to S-CSCF 152 (step S2).

S-CSCF 152 further transmits a Diameter:MAR signal specified for the MMD to HSS 153 (step S3). Required information such as a user ID is set in the signal.

HSS 153 transmits an authentication information acquisition request signal for dispatch of the authentication vector AV for the user ID, to AuC 154 (step S4).

AuC 154 calculates various parameters for the AV according to a calculation algorithm specified for the MMD (step S5), and returns an authentication information dispatch signal to HSS 153 (step S6). In this case, five AV parameters, a RAND-aka, an AUTN, an XRES, an IK, and a CK are calculated.

HSS 153 sets the five parameters in a Diameter:MAA signal specified for the MMD, and returns the Diameter:MAA signal to S-CSCF 152 as a response signal to the MAR signal (step S7).

S-CSCF 152 sets only the RAND-aka and AUTM of the five AV parameters in an SIP:401 signal specified for the MMD, and returns the SIP:401 signal to P-CSCF 151 as a response signal to the SIP:REGISTER signal (step S8).

P-CSCF 151 converts the SIP:401 signal from S-CSCF 152 into a user interface specified for the MMD network, and then relays the user interface to mobile machine 141 (step S9). The user interface is a response signal to the SIP:REGISTER signal transmitted by the mobile machine.

MMD control section 132 in mobile machine 141 considers the SIP:401 signal from P-CSCF 151 to be a challenge signal for the IMS-AKA authentication. MMD control section 132 then inputs the RAND-aka and AUTN in the signal to ISIM card 131 to allow ISIM card 131 to calculate an authentication response result (step S10).

Based on the calculation algorithm specified for the MMD, ISIM card 131 internally uses the input RAND-aka and AUTN and information held in a memory in the ISIM to reversely authenticate the network and calculate a response value (RES) to user authentication from the network (step S11). ISIM card thus generates the matching key (IK) and ciphering key (CK), which are required to establish the IPSec SA with P-CSCF 151, to respond to MMD control section 132 in mobile machine 141 (step S12).

MMD control section 132 in mobile machine 141 sets the response value (RES) received from ISIM 131, in the SIP:REGISTER signal specified for the MMD network. MMD control section 132 transmits the SIP:REGISTER signal to P-CSCF 151 as is the case with the last transmission (step S13).

P-CSCF 151 relays the SIP:REGISTER signal to S-CSCF 152 as is the case with the last transmission, according to a procedure specified for the MMD network (step S14). S-CSCF 152 compares the response value (RES) calculated by ISIM 131 in mobile machine 141 with the expected response value (XRES) for the AV calculated by AuC 154 (step S15). Thus, the user authentication is performed.

If the authentication succeeds, S-CSCF 152 sets the held IK and CK for the AV in an SIP:200 OK signal specified for the MMD. S-CSCF 152 then returns the SIP:200 OK signal to P-CSCF 151 as a response to the SIP:REGISTER signal (step S16).

P-CSCF 151 converts the SIP:200 OK signal into a user interface specified for the MMD, and relays the SIP:200 OK signal to mobile machine 141 as a response to the SIP:REGISTER signal (step S17).

At this time, P-CSCF 151 does not relay the IK and CK received from S-CSCF 152 to mobile machine 141. P-CSCF 151 instead uses the IK and CK to establish the IPSec SA with mobile machine 141 (step S18) to cipher and decipher signals transferred between P-CSCF 151 and mobile machine 141 according to the IPSec.

After receiving the SIP:200 OK signal in response to the SIP:REGISTER signal, mobile machine 141 uses the IK and CK calculated by ISIM 131 to establish the IPSec SA with P-CSCF 151 to make subsequent signals secure.

Now, a CAVE authentication sequence specified for the CDMA2000 line switching network, on which the present invention is based, similarly to the MMD network, will be described.

FIG. 4 is a sequence diagram of an example of related global challenge response authentication. FIG. 5 is a sequence diagram of an example of related unique challenge response authentication.

The CAVE authentication is classified into two types, the global challenge response authentication and the unique challenge response authentication, which are used according to the application.

As illustrated in FIG. 4, global challenge response authentication is used for normal terminal authentications, and always broadcasts a global challenge signal in which a 32-bit random number (RAND) uniquely generated by macro base station (BS) 162 is set, to a wireless section (step S21).

Each mobile machine 161 uses secret information 171 held by mobile machine 161 and the RAND as inputs and also uses a CAVE algorithm to calculate a response value (AUTHR) (step S22). Mobile machine 161 then sets the response value, together with the received RAND value, in an initial signal transmitted to the network by mobile machine 161, such as a response signal for location registration, origination, or page response.

The network relays the information (steps S23 to S25), and HLR/AC 164 finally performs the authentication (step S26).

A SMEKEY (Signaling Message Encryption Key) is generated by both mobile machine 161 and HLR/AC 164 as a by-product of the global challenge response authentication. The SMEKEY is utilized to cipher control signals after the authentication has succeeded.

A PLCM (Private Long Code Mask) is similarly generated by both mobile machine 161 and HLR/AC 164 as a by-product of the global challenge response authentication. The PLCM is utilized to cipher voice signals after the authentication has succeeded.

On the other hand, as illustrated in FIG. 5, for unique challenge response authentication, if global challenge response authentication fails or authentication is to be performed during a call, line switching network 163 transmits a challenge signal to particular mobile machine 161 (steps S31 to S32).

This procedure is performed using a signal different from the location registration signal or a call control signal. A 32-bit random number (RANDU) dedicated for use only in unique challenge is set in the challenge signal; the 32-bit random number (RANDU) is a combination of a 24-bit random number generated by HLR/AC 164 and 8 bits extracted from a particular mobile machine Id (MIN).

Mobile machine 161 uses secret information 171 held by mobile machine 161 and the RANDU as inputs and also uses the CAVE algorithm to calculate a response value (AUTHU). Mobile machine 161 then returns a response signal with the AUTHU set therein to base station (BS) 162 (step S33).

In the CAVE authentication specified for the CDMA2000 line switching network, an authentication card module UIM having the above-described authentication algorithms mounted therein is mounted in mobile machine 161 and operated.

Next, before mapping between CAVE authentication parameters and IMS-AKA authentication parameters is discussed, bit lengths specified for the CAVE authentication and the IMS-AKA authentication will be described in brief.

The parameters used for the CAVE authentication are RAND (32 bits), AUTHR (18 bits), RANDU (32 bits), AUTHU (18 bits), SMEKEY (64 bits), and PLCM (42 bits).

On the other hand, the parameters used for the IMS-AKA authentication are RAND-aka (128 bits), AUTN (128 bits), XRES/RES (32 to 128 bits), IK (128 bits), CK (128 bits), and K (128 bits).

As shown above, each of the parameter lengths for the IMS-AKA authentication is larger than each of the parameter lengths for the CAVE authentication. Thus, nesting of any of the CAVE authentication parameters into any of the IMS-AKA authentication parameters will be discussed as an alternative.

Now, the relationship between a configuration of the parameters for the IMS-AKA authentication vector (AV) and the calculation algorithm will be discussed.

The AV generated by the AuC in the MMD network is composed of the following five parameters.

AV=(RAND-aka,AUTN,XRES,IK,CK) (1)

The AUTN is configured as follows:

AUTN=(SQN eor AK,AMF,MAC) (2)

Here, “eor” means exclusive OR. SQN denotes a sequence number required for authentication synchronization between the AuC and the ISIM card in the mobile machine. The AK (Anonymity Key) denotes an authentication key calculated using the secret information (K) and RAND-aka for the IMS-AKA authentication as inputs. The AK is used to conceal raw data on the SQN in the token (AUTN) set on signals transmitted between the network and the mobile machine.

The SQN eor AK denotes the result of the exclusive OR of the SQN and the AK, and has a 48-bit length similarly to the SQN and the AK. The AMF (Authentication Management Field) is utilized for pre-agreements between the AuC and the ISIM card relating to the algorithms, such as an authentication algorithm version having a 16-bit length.

The MAC (Message Authentication Code) is utilized by the mobile machine to authenticate the network (mutual authentication). The MAC is generated by the AuC, and an XMAC is an expected value on the mobile machine side.

FIGS. 6 and 7 illustrate the relationship between the parameters and algorithms for IMS-AKA authentication. First, the calculation algorithm parameters illustrated in FIG. 6 are used in the AuC in the MMD network in the related communication system. The parameters are based on the algorithm on the AuC in the MMD network.

Second, the calculation algorithm parameters illustrated in FIG. 7 are used in the ISIM card in the mobile machine in the related communication system. The parameters are based on the algorithm in the ISIM card in the mobile machine.

As an example of the related communication system, for example, Japanese Patent Laid-Open No. 2004-235697 discloses a local switching scheme in an IP telephone system which can be easily constructed based on single station switching and authentication performed by an external base station, as well as ciphering authentication based on this scheme.

Mapping between the existing CAVE authentication information and the IMS-AKA authentication information has been proposed at a 3GPP2 standardization meeting, based on a communication system using a mobile machine having the second MMD function illustrated in FIG. 2b.

As described below, the present invention provides an improved communication system using the existing mobile machine illustrated in FIG. 2c, based on a communication system using the mobile machine that has the second MMD function.

First, the communication system using the mobile machine that has the second MMD function, proposed at the 3GPP2 standardization meeting, will be described in brief. FIG. 8 is a sequence diagram illustrating an example of a process procedure of the communication system using the related mobile machine that has the second MMD function.

As illustrated in FIG. 8, according to this scheme, when mobile machine 142 accesses MMD network 116 (step S41), HSS 153 on MMD network 116 requests HLR 155 on line switching network 114 to acquire CAVE authentication information from mobile machine 142. HLR 155 returns the CAVE authentication information calculated by AC 156 to HSS 153 (step S42).

HSS 153 separately allows AuC 154 to calculate IMS-AKA authentication information using the CAVE authentication information (step S43), and transmits the IMS-AKA authentication information containing the CAVE authentication information to S-CSCF 152.

S-CSCF 152 and P-CSCF 151 on MMD network 116 each perform a predetermined IMS-AKA authentication specified for MMD network 116, on user terminal 142 (step S44).

In this case, MMD control section 134 in mobile machine 142 extracts the random number for the CAVE authentication, which serves as an input for a CAVE authentication response to be calculated by R-UIM 133, from the IMS-AKA authentication information in the authentication challenge signal received from the network side (P-CSCF 151). MMD control section 134 provides the random number to R-UIM 133 to allow R-UIM 133 to calculate the authentication response result (step S45).

MMD control section 134 in mobile machine 142 reuses the CAVE authentication response result received from R-UIM 133 to calculate an IMS-AKA authentication response result. MMD control section 134 transmits the IMS-AKA authentication response result to the network side (P-CSCF 151) as a challenge response signal for the IMS-AKA authentication (step S46).

Thereafter, each of P-CSCF 151 and S-CSCF 152 performs a predetermined IMS-AKA authentication procedure specified for MMD network 116.

Now, how the above-described operation is performed by a communication system using the existing mobile machine illustrated in FIG. 2c will be described. FIG. 9 is a sequence diagram illustrating an example of a process procedure of a communication system using the related existing mobile machine.

Operations of the network side devices are the same as those in the communication system using the mobile machine with the second MMD function.

In the communication system using existing mobile machine 143, Femto Cell 144, a small base station, performs mapping between the CAVE authentication information and the IMS-AKA authentication information. Thus, a difference in conditions between Femto Cell 144 and MMD control section 134 in mobile machine 142 in the communication system using the mobile machine having the second MMD function has been examined.

The difference is such that MMD control section 134 in second mobile machine 142 can sufficiently acquire necessary information from R-UIM 133, which can be installed in and removed from second mobile machine 142, whereas Femto Cell 144, which uses existing mobile machine 143, can obtain information from R-UIM 135 in existing mobile machine 143 only if the information can be acquired using a CDMA2000 radio signal.

The information that cannot be obtained via the radio signal includes the SMEKEY (Signaling Message Encryption Key) and PLCM (Private Long Code Mask), which are calculated by R-UIM 135 in calculating the CAVE authentication response result.

The SMEKEY is utilized to cipher line switching control signals, and the PLCM is utilized to cipher line switching voice signals. Thus, the authentication information is prevented from flowing through the wireless section, in which eavesdropping is likely to occur.

However, existing mobile machine 143 may cipher signals using the SMEKEY and the PLCM, and Femto Cell 144 needs to decipher and convert radio signals into SIP signals for MMD network 116. Thus, the network side needs to transmit the SMEKEY and the PLCM to Femto Cell 144 using all means.

On the other hand, although the SMEKEY and the PLCM are adopted for the communication system using the mobile machine having the second MMD function, it is expected that security can be enhanced by, during mapping of the authentication information, reflecting as much of the CAVE authentication response result from the R-UIM in the IMS-AKA authentication response result as possible.

The communication system using the mobile machine that has the second MMD function utilizes three parameters, that is, the AUTHUR (Authentication Response), which is the CAVE authentication response result, the SMEKEY, and the PLCM to calculate the IMS-AKA authentication response result. However, the communication system using existing mobile machine 143 can utilize only the AUTHUR because the SMEKEY and the PLCM cannot be obtained from mobile machine 143 side as described above.

The problem to be solved by the invention relates to an authentication information mapping method improved in that with the existing IMS-AKA authentication procedure continuing to be used in MMD network 116, the CAVE authentication information generated by AC 156 in line switching network 114, particularly, the RAND, which is the authentication random number, the AUTHUR, which is the authentication response, the SMEKEY, which is the control signal ciphering key, and the PLCM, which is the voice signal ciphering signal, are appropriately transmitted to Femto Cell 144, and the CAVE authentication response result AUTHUR, which can be acquired from mobile machine 143 by Femto Cell 144, is appropriately incorporated into the IMS-AKA authentication response result to make the IMS-AKA authentication securer.

### SUMMARY OF THE INVENTION

Thus, an object of the present invention is to provide a communication system, a communication method, an authentication information managing server, and a small base station wherein when a line switching communication terminal is connected to a multimedia communication network via a small base station, the small base station can acquire necessary information on a ciphering key required to authenticate the communication terminal.

To accomplish the object, a communication system according to the present invention comprises first authentication information processing means, provided on a line switching network, for performing first authentication on a communication terminal in the line switching network, second authentication information processing means, provided on a multimedia communication network, for performing second authentication on a communication terminal in the multimedia communication network, a small base station provided on a local information communication network to communicate wirelessly with a communication terminal in the local information communication network, a line switching communication terminal performing communication via the line switching network or the local information communication network, first authentication processing means, provided in the small base station, for acquiring the first authentication information from the line switching communication terminal and transmitting the first authentication information to the second authentication information processing means, ciphering key information acquiring means, provided in the second authentication information processing means, for acquiring ciphering key information on the line switching communication terminal from the first authentication information processing means based on the first authentication obtained from the small base station, authentication information mapping means, provided in the second authentication information processing means, for mapping the ciphering key information to the second authentication information, mapping information transmitting means, provided in the second authentication information processing means, for transmitting the mapped information to the small base station, and ciphering key information extracting means, provided in the small base station, for extracting the ciphering key information from the mapped information.

The present invention also provides a communication method in a communication system comprising a first authentication information processing device provided on a line switching network to perform first authentication on a communication terminal in the line switching network, a second authentication information processing device provided on a multimedia communication network to perform second authentication on a communication terminal in the multimedia communication network, a small base station provided on a local information communication network to communicate wirelessly with a communication terminal in the local information communication network, and a line switching communication terminal performing communication via the line switching network or the local information communication network, the method comprising allowing the small base station to acquire the first authentication information from the line switching communication terminal and to transmit the first authentication information to the second authentication information processing device, allowing the second authentication information processing device to acquire ciphering key information on the line switching communication terminal from the first authentication information processing device based on the first authentication obtained from the small base station, allowing the second authentication information processing device to map the ciphering key information to the second authentication information, allowing the second authentication information processing device to transmit the mapped information to the small base station, and allowing the small base station to extract the ciphering key information from the mapped information.

The present invention also provides an authentication information managing server in a communication system comprising first authentication information processing means, provided on a line switching network, for performing first authentication on a communication terminal in the line switching network, second authentication information processing means, provided on a multimedia communication network, for performing second authentication on a communication terminal in the multimedia communication network, a small base station provided on a local information communication network to communicate wirelessly with a communication terminal in the local information communication network, and a line switching communication terminal performing communication via the line switching network or the local information communication network, the authentication information managing server comprising first authentication information processing means and second authentication information processing means, and including ciphering key information acquiring means, provided in the second authentication information processing means, for acquiring ciphering key information on the line switching communication terminal from the first authentication information processing means based on the first authentication obtained from the small base station, authentication information mapping means, provided in the second authentication information processing means, for mapping the ciphering key information to the second authentication information, and mapping information transmitting means, provided in the second authentication information processing means, for transmitting the mapped information to the small base station, the small base station extracting the ciphering key information from the mapped information.

The present invention also provides a small base station in a communication system comprising first authentication information processing means, provided on a line switching network, for performing first authentication on a communication terminal in the line switching network, second authentication information processing means, provided on a multimedia communication network, for performing second authentication on a communication terminal in the multimedia communication network, the small base station provided on a local information communication network to communicate wirelessly with a communication terminal in the local information communication network, and a line switching communication terminal performing communication via the line switching network or the local information communication network, the small base station comprising first authentication processing means for acquiring the first authentication information from the line switching communication terminal and transmitting the first authentication information to the second authentication information processing means, and ciphering key information extracting means for extracting ciphering key information from mapped information, the mapped information being obtained by acquiring the ciphering key information on the line switching communication terminal from the first authentication information processing means based on the first authentication received by the second authentication information processing means and mapping the ciphering key information to the second authentication information.

According to the present invention, when the communication terminal based on the line switching scheme is connected to the multimedia communication network via the small base station, the small base station acquires the information on the ciphering key required to authenticate the communication terminal. Thus, the small base station can simultaneously control existing, old CAVE authentication in a wireless section and IMS-AKA authentication on an MMD network.

### BRIEF DESCRIPTION OF THE DRAWINGS

FIG. 1 is a diagram of an example of a communication system relating to the present invention;

FIG. 2a is a diagram illustrating a communication system that shifts from existing line and packet switching services to multimedia service;

FIG. 2b is a diagram illustrating a communication system that shifts from the existing line and packet switching services to the multimedia service;

FIG. 2c is a diagram illustrating a communication system that shifts from the existing line and packet switching services to the multimedia service;

FIG. 3 is a sequence diagram illustrating an example of an IMS-AKA sequence for a related communication system;

FIG. 4 is a sequence diagram of an example of related global challenge response authentication;

FIG. 5 is a sequence diagram of an example of related unique challenge response authentication;

FIG. 6 is a diagram illustrating relationship among calculation algorithm parameters in an AuC on an MMD network in the related communication system;

FIG. 7 is a diagram of calculation algorithm parameters in an ISIM card in a mobile machine in the related communication system;

FIG. 8 is a sequence diagram illustrating an example of a process procedure of a communication system using a related mobile machine having a second MMD function;

FIG. 9 is a sequence diagram illustrating an example of a process procedure of a communication system using a related existing mobile machine;

FIG. 10 is a diagram of a configuration of an exemplary embodiment of a communication system according to the present invention;

FIG. 11 is a flowchart illustrating an operation of a first exemplary embodiment;

FIG. 12 is a diagram of a configuration of a second exemplary embodiment of the communication system according to the present invention;

FIG. 13 is a diagram of a configuration of an example of a Femto Cell;

FIG. 14 is a diagram of a configuration of an example of an HSS and an AuC;

FIG. 15 is a sequence diagram of signals in the second exemplary embodiment of the communication system according to the present invention;

FIG. 16 is a diagram illustrating a part of a sequence between the HSS/AuC and an HLR/AC according to the present invention;

FIG. 17a is a diagram illustrating an example of a mapping method in the HSS/AuC in the MMD network in the communication system according to the present invention;

FIG. 17b is a diagram illustrating an example of the mapping method in the HSS/AuC in the MMD network in the communication system according to the present invention;

FIG. 18a is a diagram illustrating an example of a mapping method in the Femto Cell in the communication system according to the present invention;

FIG. 18b is a diagram illustrating an example of the mapping method in the Femto Cell in the communication system according to the present invention;

FIG. 19 is a diagram illustrating the relationship among authentication parameters in the AuC observed during AV generation;

FIG. 20 is a diagram illustrating the relationship between the authentication parameters and a mutual authentication function in a SIM card;

FIG. 21 is a diagram illustrating an example of a signal sequence according to the present proposal;

FIG. 22 is a diagram illustrating the logic of AV generation in the proposed HSS/AuC; and

FIG. 23 is a diagram illustrating AV logic in the proposed Femto Cell.

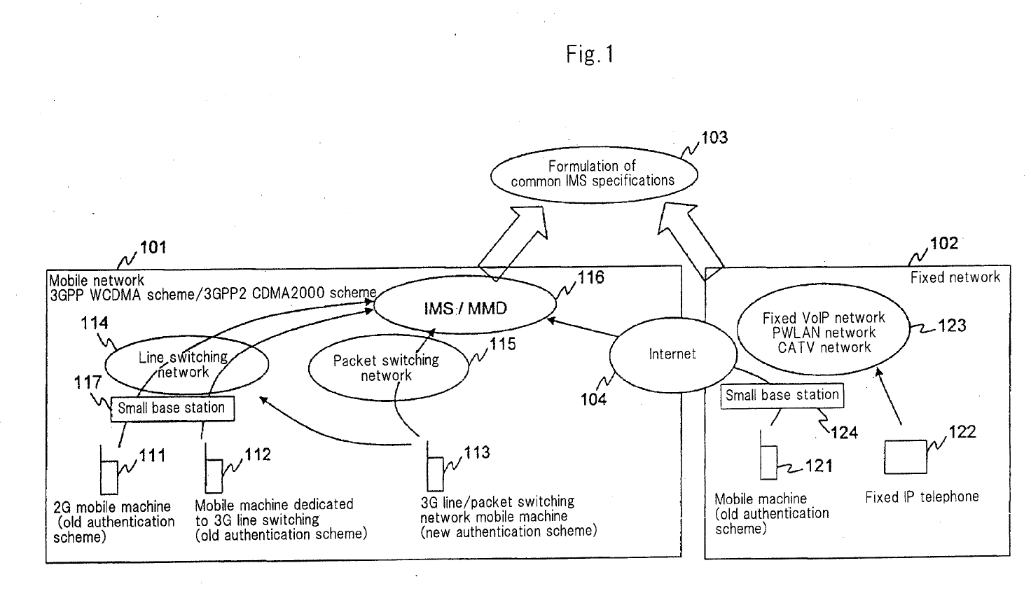

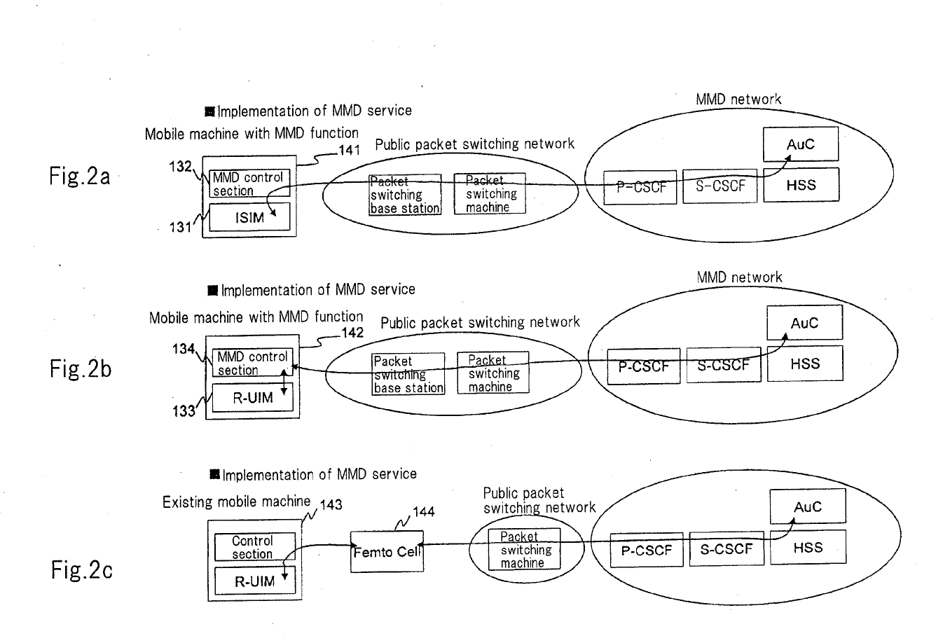

### DETAILED DESCRIPTION OF THE PREFERRED EMBODIMENTS

First, a gist of the present invention will be described. The present invention proposes a method of mapping, in a CDMA2000 mobile communication network, second generation CAVE authentication information to IMS-AKA authentication information defined for an MMD network in order to support control of accesses, to the MMD network, of a mobile machine dedicated to old line switching that supports second generation CAVE authentication using a relatively small base station (Femto Cell).

Main features of the present invention are devices in the MMD network, that is, a server HSS (Home Subscriber Server) that manages information on subscribers to multimedia service, a server AuC (Authentication Center) which operates in conjunction with the server HSS or inside the server HSS to generate and manage, for each subscriber, IMS-AKA (IMS Authentication and Key Agreement) authentication information required to perform access control for the multimedia service, and a small base station (Femto Cell) having the ability to recognize radio waves transferred between the small base station and an existing CDMA2000 mobile machine and to transmit and receive the radio waves to and from a server P-CSCF (Proxy Call Session Control Function) in the MMD network as SIP signals, the server P-CSCF having a proxy call and session control function.

A radio wave coverage of existing Femto Cells ranges from a radius of 10 m to 50 m for small Femto Cells to a radius of about 100 mm.

A possible application of the Femto Cell is to support integrated fixed and mobile service FMC (Fixed Mobile Convergence); the Femto Cell is placed in a home having an established broad band environment so that when a user of the mobile machine is at home, the multimedia service is provided utilizing inexpensive broad band communication via the Femto Cell, and when the user goes out, existing communication is provided utilizing a public base station.

On the other hand, the Femto Cell is expected to have a narrow radio wave coverage and to be small and inexpensive. Thus, the Femto Cell is expected to be utilized as a public base station for zones blind to 3D radio waves by taking advantage of the characteristics of the Femto Cell.

The devices located in a signal flow path in the present invention are defined as follows.

An existing mobile machine is defined as an MS (Mobile Machine). A module incorporated into the mobile machine or composed of a small card which is installed in and removed from the mobile machine and to which contract ID information or authentication information is saved is defined as a UIM (User Identification Module); when the mobile machine MS accesses a CDMA2000 mobile communication network, the module operates in conjunction with the mobile machine MS to calculate and manage the authentication information using a CAVE (Cellular Authentication and Voice Encryption algorithm) scheme that is an old authentication scheme. The small card that is installed in and removed from the mobile machine MS is defined as an R-UIM (Removal UIM). A server having a call and session control function to perform actual VoIP and multimedia service in the MMD network is defined as an S-CSCF (Serving Call Session Control Function). A server which is a device in a CDMA2000 line switching network and which manages information on subscribers to various voice services for mobile machines dedicated to the old line switching as well as positional information on the mobile machines is defined as an HLR (Home Location Register). A server operating in conjunction with the server HLR or inside the server HLR to generate and manage old CAVE authentication information for each subscriber is defined as an AC (Authentication Center).

For convenience, the present invention uses two types of abbreviations for the Authentication Center according to the corresponding schemes; the Authentication Center on the MMD network is defined as an AuC, and the Authentication Center on the line switching network is defined as the AC.

Exemplary embodiments of the present invention will be described below with reference to the accompanying drawings.

First, a first exemplary embodiment of the present invention will be described.

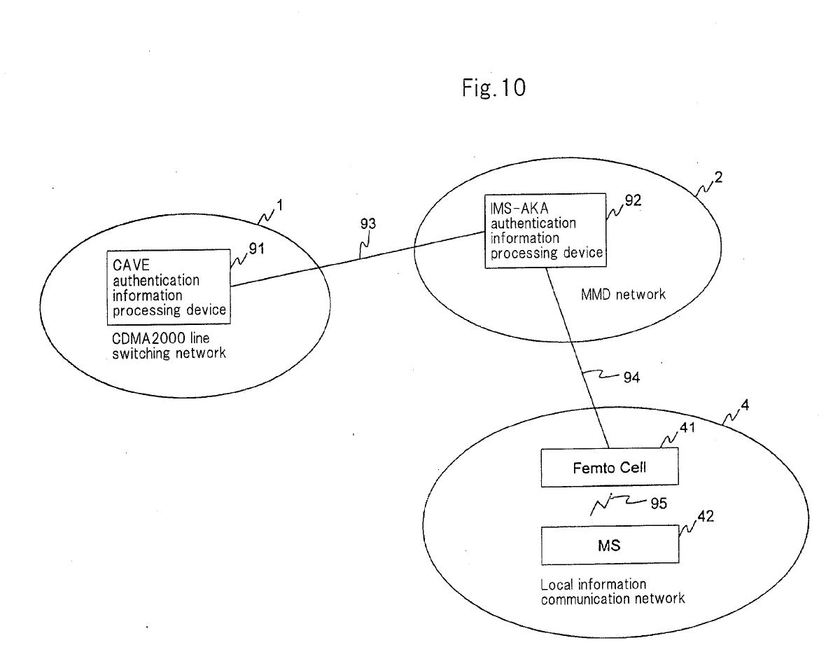

FIG. 10 is a diagram of a configuration of the first exemplary embodiment of a communication system according to the present invention.

As illustrated in FIG. 10, the first exemplary embodiment of the communication system according to the present invention includes CDMA2000 line switching network 1, MMD network 2, and local information communication network 4 such as a LAN (Local Area Network).

Line switching network 1 includes CAVE authentication information processing device 91.

MMD network 2 includes IMS-AKA authentication information processing device 92.

Local information communication network 4 includes small base station (Femto Cell) 41 and communication terminal (MS) 42.

CAVE authentication information processing device 91 in line switching network 1 and IMS-AKA authentication information processing device 92 in MMD network 2 are connected together via transmission line 93.

IMS-AKA authentication information processing device 92 in MMD network 2 and Femto Cell 41 in local information communication network 4 are connected together via transmission line 94.

Femto Cell 41 in local information communication network 4 and communication terminal 42 are connected together via radio 95.

Communication terminal 42 is based on the CDMA2000 scheme and can be connected to an existing public base station (not illustrated in the drawings) in line switching network 1 or Femto Cell 41 in local information communication network 4.

CAVE authentication information processing device 91 includes a function for CAVE authentication.

IMS-AKA authentication information processing device 92 includes a function for IMS-AKA authentication.

Communication terminal 42 holds CAVE authentication information.

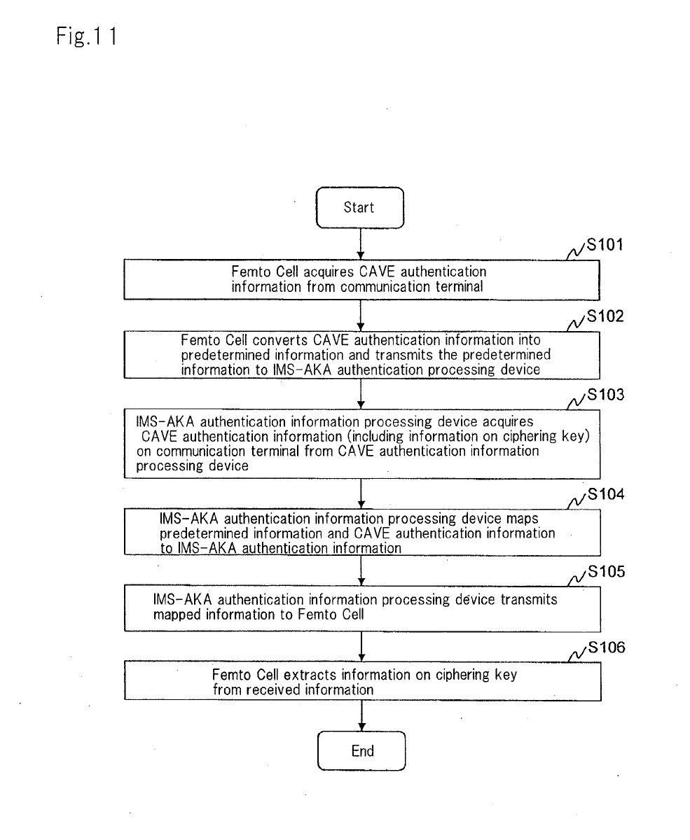

Next, an operation of the first exemplary embodiment will be described. FIG. 11 is a flowchart illustrating the operation of the first exemplary embodiment.

Femto Cell 41 acquires the CAVE authentication information from communication terminal 42 (step S101).

Femto Cell 41 converts the CAVE authentication information into predetermined information, and transmits the predetermined information to IMS-AKA authentication information processing device 92 (step S102).

IMS-AKA authentication information processing device 92 acquires the CAVE authentication information on communication terminal 42 from CAVE authentication information processing device 91 (step S103).

The CAVE authentication information includes information on a ciphering key for deciphering a cipher transmitted by communication terminal 42.

IMS-AKA authentication information processing device 92 maps the predetermined information and the CAVE authentication information obtained from CAVE authentication information processing device 91 to the IMS-AKA authentication information (step S104).

IMS-AKA authentication information processing device 92 transmits the mapped IMS-AKA authentication information to Femto Cell 41 (step S105).

Femto Cell 41 extracts the information on the ciphering key from the received IMS-AKA authentication information (step S106).

As described above, according to the first exemplary embodiment of the present invention, when the line switching communication terminal is connected to the MMD network via the small base station, the small base station acquires the information on the ciphering key required to authenticate the communication terminal. Thus, the small base station can simultaneously control existing, old CAVE authentication in a wireless section and IMS-AKA authentication on the MMD.

Next, a second exemplary embodiment of the present invention will be described.

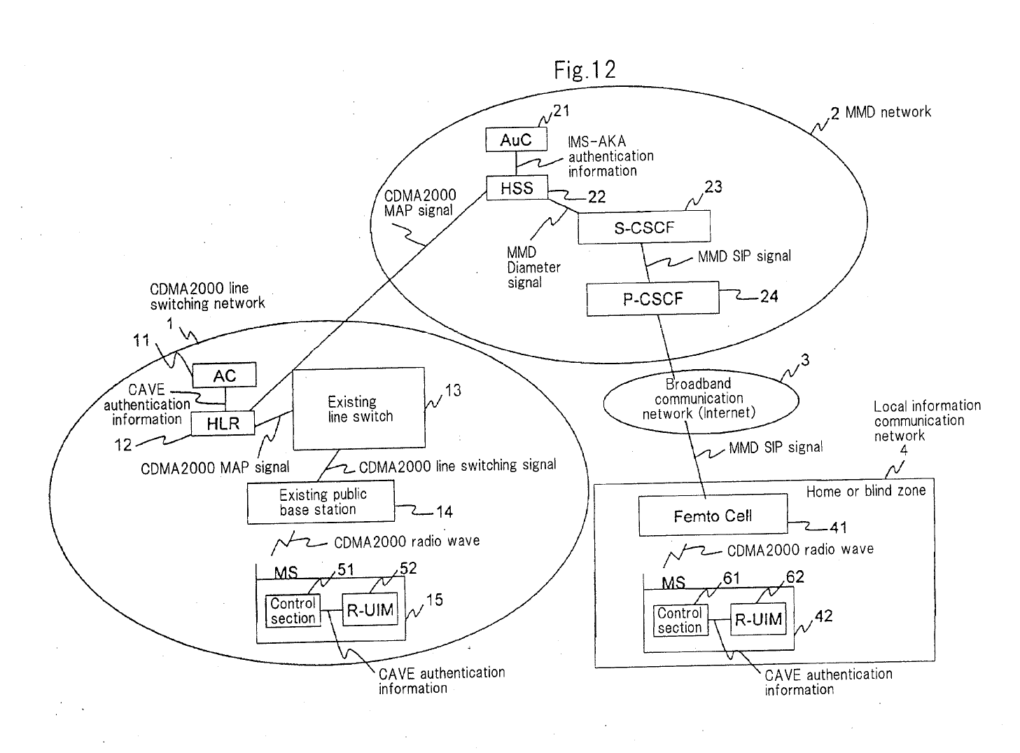

FIG. 12 is a diagram of a configuration of the second exemplary embodiment of the communication system according to the present invention.

As illustrated in FIG. 12, the second exemplary embodiment of the communication system according to the present invention includes, by way of example, CDMA2000 line switching network 1, MMD network 2, broadband communication network 3 such as the Internet, and local information communication network 4 such as the LAN (Local Area Network).

CDMA2000 line switching network 1 includes server AC 11, server HLR 12, existing line switch 13, existing public base station 14, and communication terminal (MS) 15.

Communication terminal 15 includes control section 51 and R-UIM 52.

MMD network 2 includes server AuC 21, server HSS 22, server S-CSCF 23, and server P-CSCF 24.

Local information communication network 4 includes small base station (Femto Cell) 41 and communication terminal (MS) 42.

Communication terminal 42 includes control section 61 and R-UIM 62.

Communication terminals 15 and 42 are configured similarly and are based on the CDMA2000 scheme, and can be connected to existing public base station 14 or Femto Cell 41.

Communication terminal 15 in line switching network 1 wirelessly communicates with existing public base station 14 using a CDMA2000 radio wave. CAVE authentication information is processed between control section 51 in communication terminal 15 and R-UIM 52.

Existing public base station 14 communicates with existing line switch 13 using a CDMA2000 line switching signal.

Existing line switch 13 communicates with server HLR 12 using a CDMA2000 MAP signal.

CAVE authentication information is processed between server AC 11 and server HLR 12.

IMS-AKA authentication information is processed between server AuC 21 and server HSS 22 in MMD network 2.

Server HSS 22 communicates with server HLR 12 in line switching network 1 using the CDMA2000 MAP signal. Server HSS 22 communicates with server S-CSCF 23 using an MMD Diameter signal.

Server S-CSCF 23 communicates with server P-CSCF 24 using an MMD SIP signal.

Server P-CSCF 24 communicates with Femto Cell 41 in local information communication network 4 via broadband communication network 3 using the MMD SIP signal.

Femto Cell 41 communicates with communication terminal 42 in local information communication network 4 using a CDMA2000 radio wave. CAVE authentication information is processed between control section 61 in communication terminal 42 and R-UIM 62.

In the present exemplary embodiment, an example of local information communication network 4 is a communication network provided in a home or a blind zone.

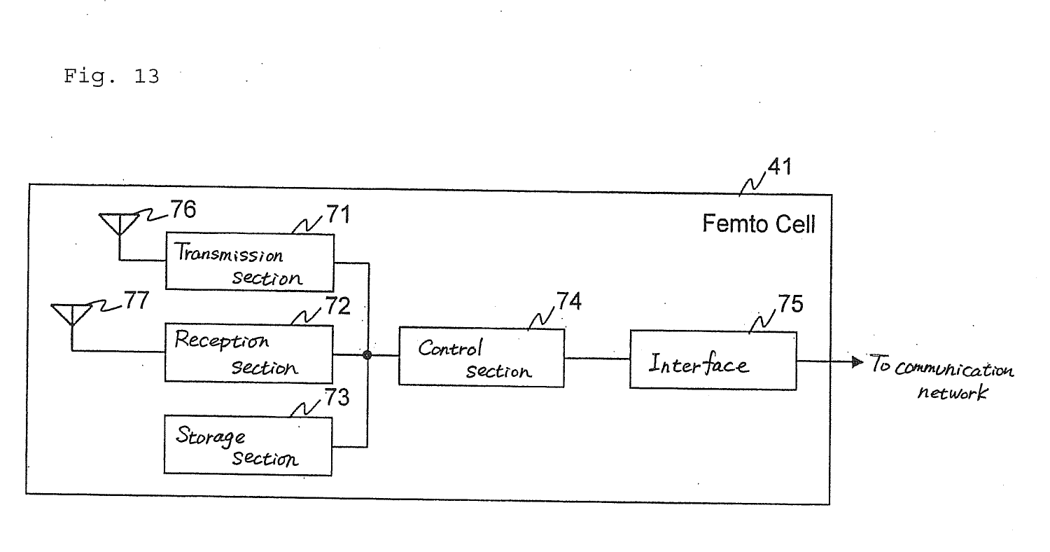

Next, a configuration of an example of Femto Cell 41 will be described. FIG. 13 illustrates the configuration of the example of Femto Cell 41.

As illustrated in FIG. 13, the example of Femto Cell 41 includes transmission section 71, reception section 72, storage section 73, control section 74, interface 75, and antennas 76 and 77.

Transmission section 71 transmits signals to communication terminal 42 in local information communication network 4 via antenna 76 using the CDMA2000 radio wave.

Reception section 72 receives signals from communication terminal 42 in local information communication network 4 via antenna 77 using the CDMA2000 radio wave.

Storage section 73 stores information required for communication.

Control section 74 controls transmission section 71, reception section 72, and storage section 73. Control section 74 transmits processed information to server P-CSCF 24 in MMD network 2 via interface 75 and external broadband communication network 3.

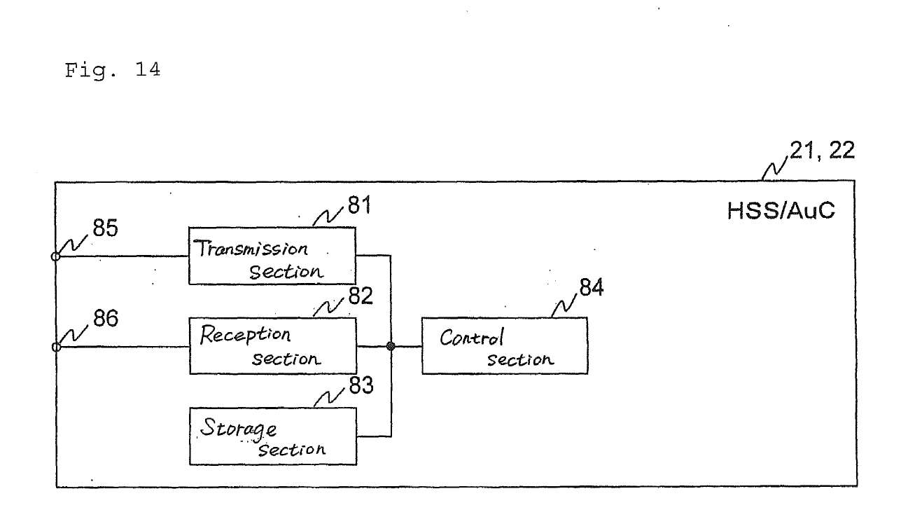

Now, a configuration of an example of HSS 22 and AuC 21 will be described. FIG. 14 is a diagram of the configuration of the example of HSS 22 and AuC 21. HSS 22 and AuC 21 are configured similarly except for processing in control section 84.

As illustrated in FIG. 14, the example of HSS 22 and AuC 21 includes transmission section 81, reception section 82, storage section 83, control section 84, output terminal 85, and input terminal 86.

Transmission section 81 transmits signals via output terminal 85.

Reception section 82 receives signals via input terminal 86.

Storage section 83 stores information required for communication.

Control section 84 controls transmission section 81, reception section 82, and storage section 83.

Next, the operation of HSS 22 will be described. Transmission section 81 transmits information to server HLR 12 in line switching network 1 via output terminal 85 using the CDMA2000 MAP signal. Reception section 82 receives, via input terminal 86, information transmitted by server HLR 12 in line switching network 1, using the CDMA2000 MAP signal.

Transmission section 81 transmits information to server S-CSCF 23 via output terminal 85 using the MMD Diameter signal. Reception section 82 receives, via input terminal 86, information transmitted by server S-CSCF 23, using the MMD Diameter signal.

Transmission section 81 and reception section 82 also communicate with server AuC 21.

Now, an operation of server AuC 21 will be described. Transmission section 81 transmits IMS-AKA authentication information to reception section 82 on server HSS 22 side via output terminal 85.

Reception section 82 receives the IMS-AKA authentication information from transmission section 81 on server HSS 22 side via input terminal 86.

A signal sequence according to the second exemplary embodiment will be described.

The second exemplary embodiment of the communication system according to the present invention includes existing mobile machine (MS with R-UIM) 42 in which a R-UIM card provided with an existing CAVE authentication function is mounted, small base station (Femto Cell) 41, servers P-CSCF 24 and S-CSCF 23 specified for the MMD network, servers HSS/AuC 22, 21, and HLR/AC 12, 11 on existing CDMA2000 line switching network.

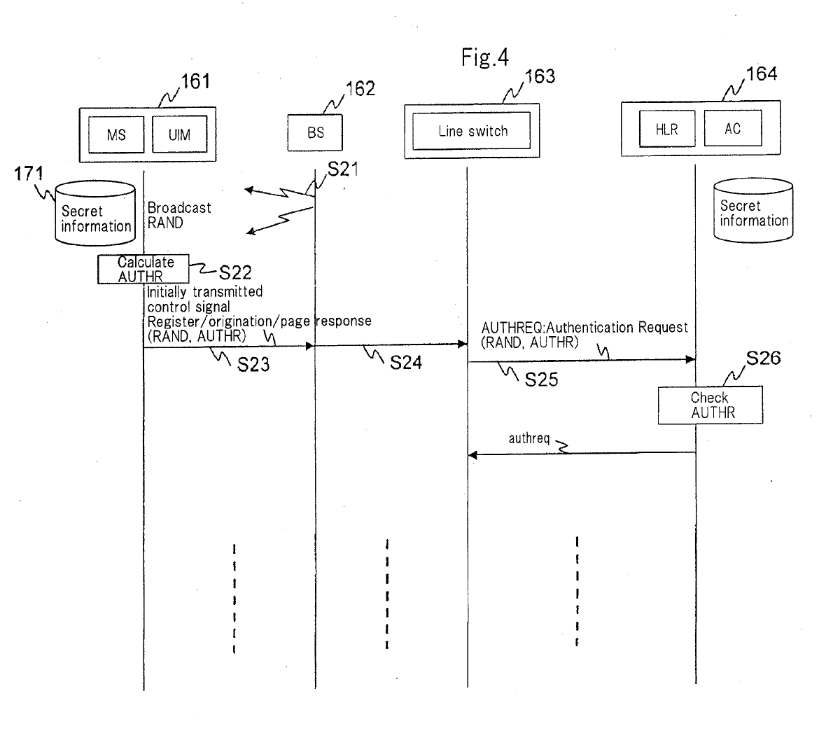

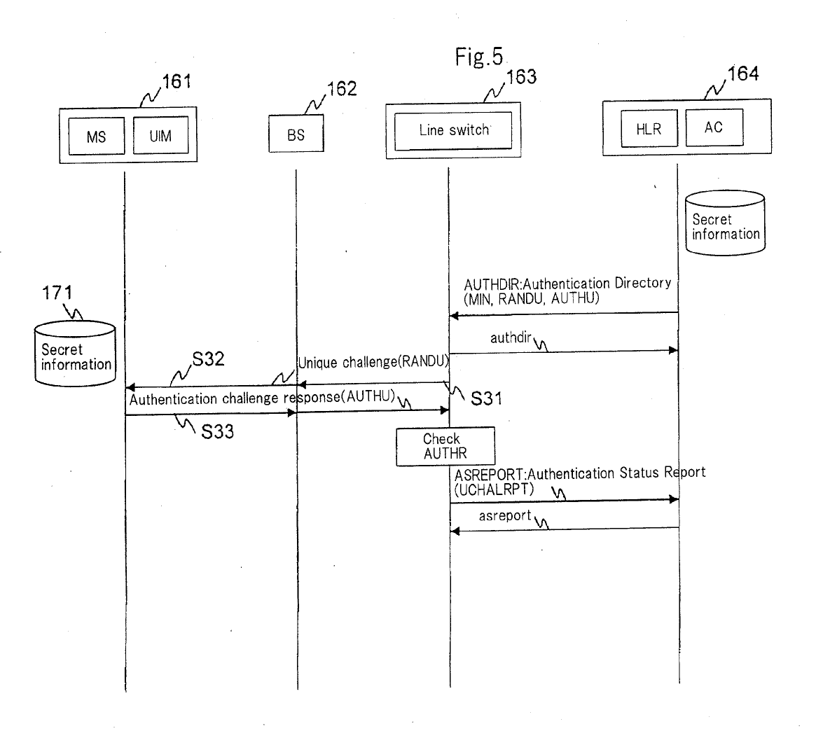

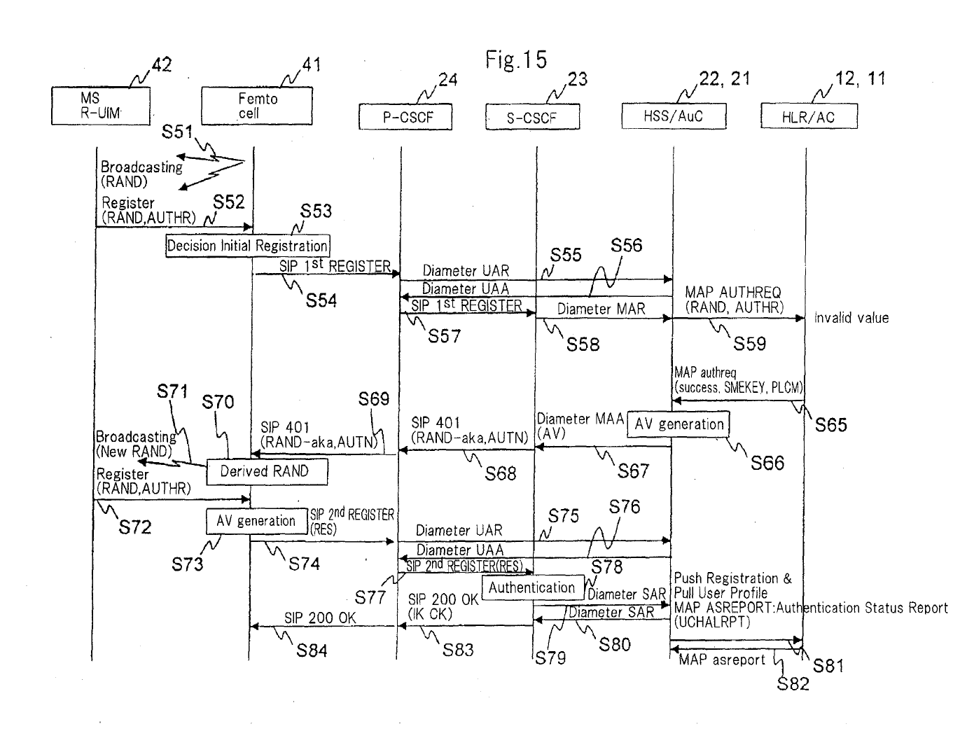

FIG. 15 is a sequence diagram of signals in the second exemplary embodiment of the communication system according to the present invention. First, the Femto Cell performs an operation similar to the global challenge response in the CDMA2000 line switching network illustrated in FIG. 4.

Femto Cell 41 broadcasts the global challenge signal containing the 32-bit random number (RAND) to the radio section (step S51).

In response to the global challenge signal, existing mobile machine and R-UIM 42 (hereinafter referred to as existing mobile machine 42) sets the global challenge response value (AUTHR) calculated according to the CAVE authentication algorithm using the received RAND and the secret information as inputs, in the initial signal (line switching location registration signal) transmitted to the network, such as the Register signal. Existing mobile machine 42 transmits the Register signal to the Femto Cell (step S52).

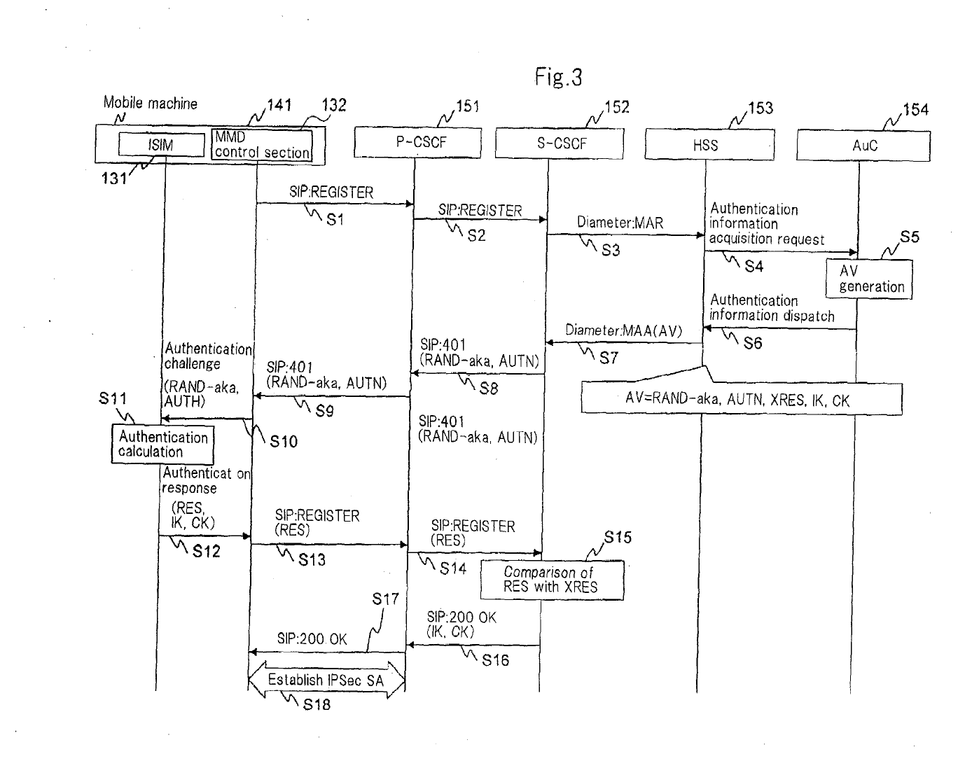

Then, Femto Cell 41 internally converts the Register signal into the SIP:REGISTER signal (see step S1 in FIG. 3), specified for the MMD network and illustrated in FIG. 3. In this case, the reception signal from existing mobile machine 42 in Femto Cell 41 is not encoded.

Even if the reception signal is encoded, Femto Cell 41 can decode the signal using old authentication information or if it can not decode the signal immediately returns a failure signal in response to the location registration signal (Register) from the existing mobile station 42 to allow existing mobile machine 42 to retransmit the non-ciphered location registration signal.

As a result of the above-described procedure, Femto Cell 41 determines whether or not to transmit an SIP protocol 1st REGISTER signal to P-CSCF 24 for the MMD network in response to the request from existing mobile machine 42 (step S53).

Then, Femto Cell 41 transmits the SIP protocol 1st REGISTER (SIP 1st REGISTER) signal to P-CSCF 24 (step S54). The signal is not ciphered. The signal contains information shows that the signal indicates user access via Femto Cell 41. No authentication information is set in the signal.

P-CSCF 24 transmits a Diameter protocol UAR signal (Diameter UAR signal) to HSS/AuC 22, 21 in order to inquire about S-CSCF address information on an S-CSCF capable of controlling sessions with the user (step S55).

HSS/AuC 22, 21 returns a Diameter protocol UAA signal (Diameter UAA signal) to P-CSCF 24 (step S56). The signal contains the S-CSCF address information.

P-CSCF 24 receives in step S56 and transfers the SIP 1st REGISTER signal transmitted in step S54, to the S-CSCF address obtained (step S57).

S-CSCF 23 transmits a Diameter protocol MAR signal (Diameter MAR signal) to HSS/AuC 22, 21 in order to inquire about the user's IMS-AKA authentication information (step S58).

If P-CSCF 24 has set authentication information in the SIP REGISTER signal, S-CSCF 23 checks the authentication information against authentication information saved to S-CSCF 23 to determine whether or not the mobile machine can be authenticated. Upon determining that the mobile machine cannot be authenticated (the authentication information from existing mobile machine 42 is old), S-CSCF 23 executes step S58.

Furthermore, the signal contains information shows that the signal indicates user access via Femto Cell 41; the information is set in step S54 and taken over to step S57.

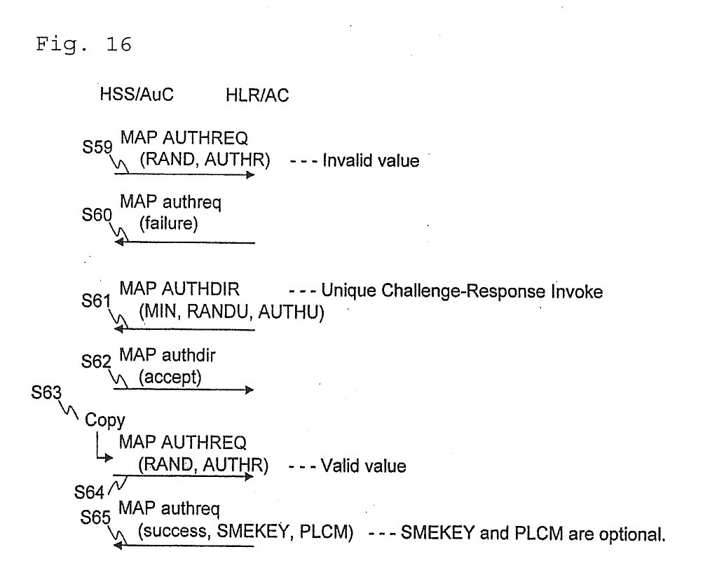

FIG. 16 is a diagram illustrating a part of a sequence between HSS/AuC 22, 21 and HLR/AC 12, 11 according to the present invention (steps S59 to S65).

HSS/AuC 22, 21 searches a database thereof based on a user ID in the received MAR signal to determine whether a service contract for Femto Cell 41 is present and to confirm the information in the received MAR signal indicating that the signal corresponds to user access via Femto Cell 41. HSS/AuC 22, 21 then transmits an existing MAP protocol AUTHREQ signal (MAP AUTHREQ signal) to inquire of HLR/AC 12, 11 for the user's CAVE authentication information dedicated to line switching (step S59).

The random number (RAND) and response value (AUTHR) for invalid global challenge responses such as “all 0” are set in the signal.

HLR/AC 12, 11 determines that the authentication information (RAND and AUTHR) in the received AUTHREQ signal is “all 0” and invalid (invalid value). HLR/AC 12, 11 then performs a unique challenge response procedure (Unique Challenge-Response invoke), as in the case of the related art.

Before performing the procedure, HLR/AC 12, 11 returns an appropriate error response (MAP authreq (failure)) to HSS/AuC 22, 21 in response to AUTHREQ signal in step S59.

In response to the error response, HLR/AC 12, 11 transmits, to HSS/AuC 22, 21, a MAP protocol AUTHDIR (MAP AUTHDIR) signal for requesting the unique challenge response authentication from the user (step S61).

The signal contains the random number (RANDU) and expected response value (AUTHU) newly generated by the MIN, which corresponds to the mobile user ID, and HLR/AC 12, 11 in step S60.

HSS/AuC 22, 21 returns an appropriate response (MAP authdir) in response to the signal in step S61 (step S62). To determine the key information SMEKEY and PLCM, which are required to cipher signals between existing mobile machine 42 and Femto Cell 41 and which are optional, HSS/AuC 22, 21 copies the random number (RANDU) and expected response value (AUTHU) for the unique challenge response) which have been received in step S61, as the random number (RAND) and expected response value (AUTHU) for the global challenge (step S63).

Then, HSS/AuC 22, 21 transmits an MAP protocol AUTHREQ signal with the random number and expected response value set therein to HLR/AC 12, 11 (step S64).

HLR/AC 12, 11 determines the global challenge response authentication information (RAND and AUTHR) received in step S64 has a valid value (this makes sense because HLR/AC 12, 11 has generated the global challenge response authentication information in steps S60 and S61). HLR/AC 12, 11 uses the received RAND and AUTHR and the existing algorithm to generate the key information SMEKEY and PLCM, which are required to cipher signals between existing mobile machine 42 and Femto Cell 41 and which are optional according to an operator policy.

HLR/AC 12, 11 returns an appropriate response signal to HSS/AuC 22, 21 in response to the signal in step S64 (step S65).

The SMEKEY and PLCM determined after the determination of the validity (Valid value) of the above-described global challenge response authentication information (RAND and AUTHR) are set in the response signal. Since the SMEKEY and PLCM are optional, if the ciphering is not performed, the information elements are not set or “all 0” is set. This operation is as specified in the related art.

HSS/AuC 22, 21 uses the RAND and AUTHR, which are line-switching CAVE authentication information elements obtained in steps S62 and S63, and the SMEKEY and PLCM, obtained in step S65, to first determine the RAND-aka and SQN, which are elements of the IMS-AKA authentication information, according to the method of mapping between CAVE authentication information and IMS-AKA authentication information according to the present invention.

Then, HSS/AuC 22, 21 uses the RAND-aka and SQN to determine the AUTN, XRES, CK, and IK, which are the other elements of the IMS-AKA authentication information, according to a procedure specified for the IMS-AKA authentication. HSS/AuC 22, 21 then saves the determined five parameters, the RAND-aka, AUTN, XRES, CK, and IK, to the database thereof for each user as an IMS-AKA authentication information vector set (AV) for the SIP 1st REGISTER request valid period for the user (step S66).

As a response signal to the Diameter protocol MAR signal in step S58, HSS/AuC 22, 21 transmits a Diameter protocol MAA signal to S-CSCF 23 (step S67).

The AV determined in step S66 is set in the Diameter protocol MAA signal and combined with the user ID and also saved to the database of S-CSCF 23.

Upon receiving the Diameter MAA signal with the AV set therein as a success response, S-CSCF 23 returns an SIP protocol 401 response to P-CSCF 24 as a response signal to the signal in step S57 (step S68).

Only the RAND-aka and AUTN of the five AV parameters received in step S67 are set in the SIP protocol 401 response.

The SIP 401 response received in step S68 as a response signal to the signal in step S54 is transferred from P-CSCF 24 to Femto Cell 41 (step S69).

Based on the RAND-aka in the signal received in step S69, Femto Cell 41 extracts the CAVE authentication random number (RAND) according to the authentication information mapping method according to the present invention (step S70). Femto Cell 41 broadcasts the random number (RAND) to the wireless signal section as a global challenge signal (step S71).

Upon receiving the global challenge signal containing the new RAND value, existing mobile machine 42 provides the signal to the UIM mounted in existing mobile machine 42 to allow the UIM to calculate the response code (AUTHR) for the global challenge according to the algorithm specified for the CAVE authentication.

In this case, if the signal in the wireless section is ciphered according to the option specified by the operator, then at the same time, the UIM internally calculates the SMEKEY and the PLCM. This information is saved to memory in existing mobile machine 42. Only the RAND received in step S71 and the AUTHR internally calculated by the UIM are set in the location registration signal (Register). The location registration signal is transmitted to Femto Cell 41 (step S72).

Upon receiving the second location registration signal (Register) from the mobile machine, Femto Cell 41 uses the authentication information mapping method according to the present invention as well as the RAND-aka and AUTN received in step S69 to overwrite the RAND-aka with the AUTHR value received in step S72.

Femto Cell 41 then uses a method specified for the existing IMS-AKA authentication to uniquely calculate the IMS-AKA response code (RES) and the CK and IK (step S73).

Then, Femto Cell 41 uses a method specified for the MMD network to set the RES value calculated in step S73, in an SIP protocol 2nd REGISTER signal, and transmits the signal to P-CSCF 24 (step S74).

P-CSCF 24 transmits the Diameter protocol UAR signal to HSS/AuC 22, 21 in order to make an inquiry for S-CSCF address information on the S-CSCF that is capable of controlling sessions with the user (step S75).

HSS/AuC 22, 21 returns the Diameter protocol UAA signal to P-CSCF 24 (step S76).

The Diameter protocol UAA signal contains the S-CSCF address information.

The same address information as that on S-CSCF 23 stored in HSS/AuC 22, 21 in step S58 is set in the S-CSCF address information.

P-CSCF 24 receives and transfers the SIP 1st REGISTER signal transmitted in step S74 to the S-CSCF 23 address obtained (step S77).

S-CSCF 23 performs the IMS-AKA authentication specified for the MMD network (step S78).

S-CSCF 23 performs the IMS-AKA authentication specified for the MMD network by memorizing the AV in the signal received from HSS/AuC 22, 21 in step S67 and checks the expected response value (XRES) in the AV against the response value (RES) from the user terminal in the signal which has been received in step S77.

When the authentication succeeds, S-CSCF 23 first reports the successful authentication to HSS/AuC 22, 21, which stores the report (push). S-CSCF 23 then transmits an SAR signal according to the Diameter protocol to HSS/AuC 22, 21 in order to download (pull) the user's contract information held by HSS/AuC 22, 21 into the database thereof (step S79).

HSS/AuC 22, 21 updates the user's status on the database thereof to “location registered” and formally saves the related server information (the address information on S-CSCF 23) to the database. Thereafter, HSS/AuC 22, 21 edits the user's contract information using a method specified for the existing MMD network, and transmits a relevant Diameter SAA signal to S-CSCF 23 as a response signal to the signal in step S79 (step S80).

After step S80, if the user attempts to access the MMD network via the small base station, HSS/AuC 22, 21 transmits an MAP protocol ASREPORT signal to HLR/AC 12, 11 as a report of the result of the CAVE authentication in the existing line switching network (step S81).

In response to the MAP protocol ASREPORT signal, HLR/AC 12, 11 returns an appropriate response signal to HSS/AuC 22, 21 (step S82).

Upon receiving the signal in step S80, S-CSCF 23 stores the user contract information contained in the signal, and returns an SIP protocol 200 OK signal to P-CSCF 24 as a response signal to the signal in step S77 (step S83).

Although the AV received from HSS/AuC 22, 21 in step S67 is pre-stored in the SIP protocol 200 OK signal according to an existing IMS-AKA authentication procedure, only the IK and CK contained in the signal are set.

Upon receiving the SIP 200 OK signal (success response) transmitted in response to the SIP 2nd REGISTER in step S83, P-CSCF 24 returns the SIP 200 OK signal to Femto Cell 41 as a response signal to the signal in step S74 (step S84).

The IK and CK are not set in the SIP 200 OK signal. Thereafter, P-CSCF 24 operates to establish the IPSec SA (Security Association) with the user terminal side (in the present invention, Femto Cell 41) using the IK and CK as input keys for relevant calculations, according to a procedure specified for the existing MMD network.

Upon receiving the SIP 200 OK signal, Femto Cell 41 also performs a specified operation for a similar purpose. Signals subsequently exchanged between Femto Cell 41 and P-CSCF 24 flow on the established IPSec SA. This prevents possible alteration of the signals and possible impersonation and allows secrets to be kept, thus enabling secure communication.

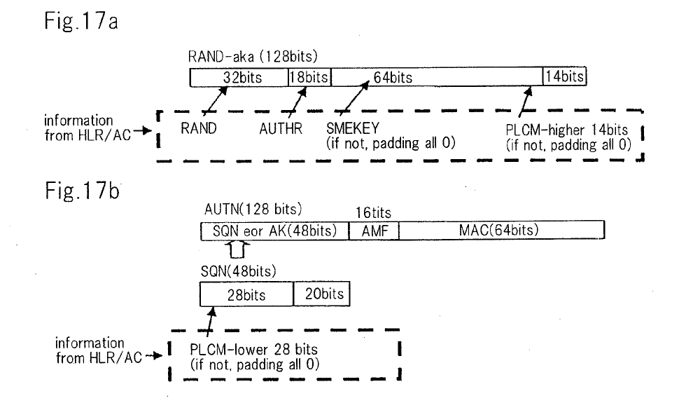

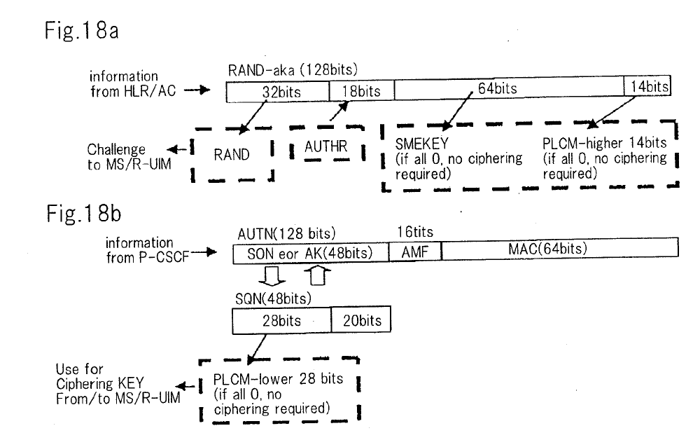

Now, the method of mapping between CAVE authentication information and IMS-AKA authentication information according to the present invention will be described. FIGS. 17a and 17b are diagrams illustrating an example of the mapping method in the HSS/AuC in the MMD network in the communication system according to the present invention. FIGS. 18a and 18b are diagrams illustrating an example of the mapping method in the Femto Cell in the communication system according to the present invention. FIGS. 17a and 17b illustrates the mapping on the AuC side in the MMD network. FIGS. 18a and 18b illustrate the mapping in the Femto Cell.

An example of an operation of the communication system according to the present invention will be described with reference to FIGS. 17a, 17b, 18a, and 18b. The RAND-aka and the SQN are expressed by the following Formulae (3) and (4).

RAND-aka=RAND∥AUTHR∥SMEKEY∥PLCM higher 14 bits (3)

SQN=PLCM lower 28 bits∥SEQ (4)

The left side of each of Formulae (3) and (4) indicates a parameter for the IMS-AKA authentication information. The right side of the formula indicates parameters for the CAVE authentication information. The SEQ in Formula (4) means remaining bits that can be used for the original purpose of the SQN specified for the IMS-AKA authentication, and the usage of the SEQ can be defined according to the operator policy. However, in the present invention, the SEQ will not be discussed in further detail.

The symbol “∥” means that the parameters are joined together with specified bit lengths of the parameters in a right side remaining unchanged.

According to the present invention, the RAND-aka and SQN mapped by HSS/AuC 22, 21 in the MMD network are used to complete the remaining parameters specified for the network side for the IMS-AKA authentication, that is, the AUTN, XRES, IK, and CK, according to the specified algorithm (step S66 in FIG. 15). Furthermore, Femto Cell 41 uses the RAND-aka and AUTN for the IMS-AKA authentication challenge received from the MMD network to extract the information required for the CAVE authentication to perform the specified CAVE authentication between the existing mobile machine and the network (step S70 in FIG. 15). Moreover, Femto Cell 41 uses the resulting AUTHR and the received RAND-aka and AUTN to calculate the parameters specified for the user side for the IMS-AKA authentication, that is, the XMAC, RES, CK, and IK, according to the specified algorithm (step S73 in FIG. 15).

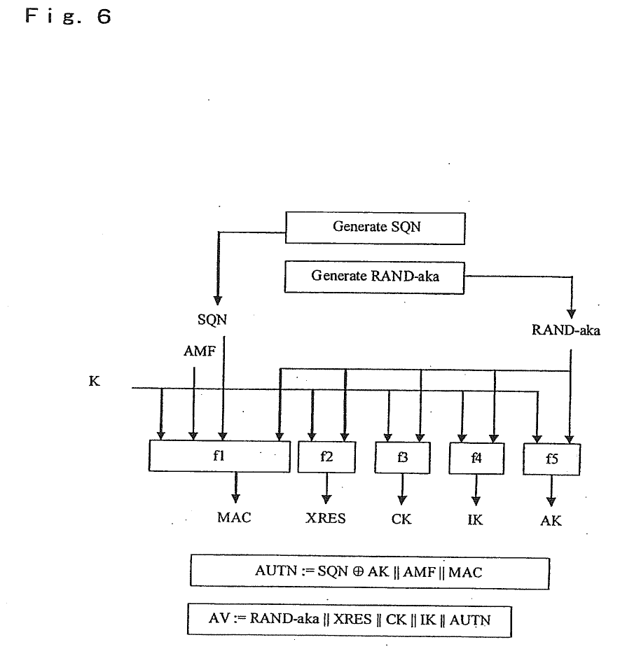

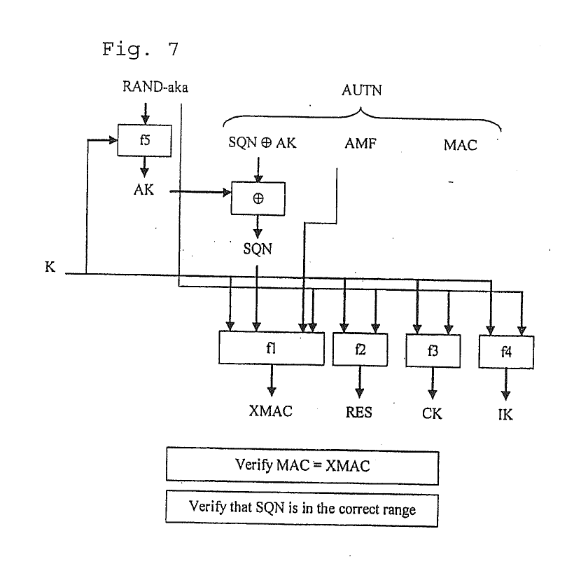

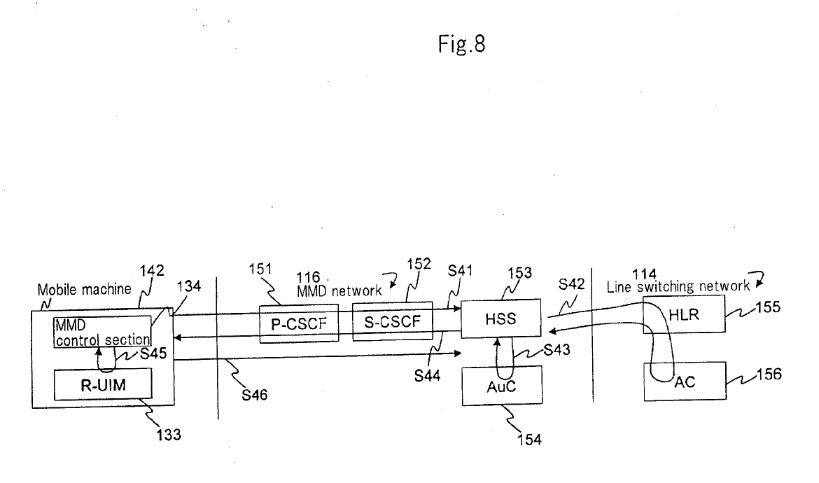

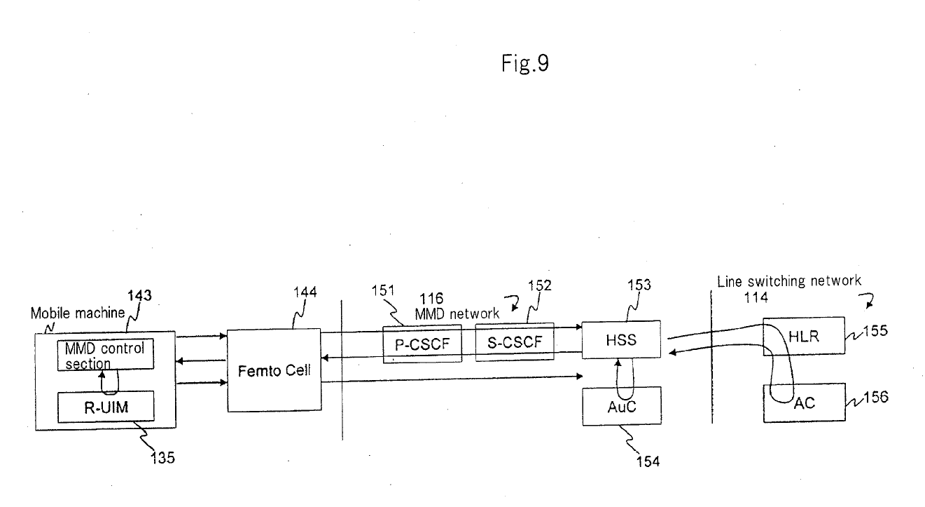

Now, the reason for proposing the authentication information mapping method according to the present invention will be described. As seen in FIGS. 6 and 7, which relate to the present invention, the RAND-aka and secret information (K) for MMD authentication are always used as inputs for calculation of the output parameters. The information K cannot be carried in an old CAVE-authentication mobile machine with the R-UIM card mounted therein, and thus cannot be used to authenticate the user.

In the present case, the K may be treated as a fixed value such as all “0” or a value from the provider and will not be discussed in further detail.

Furthermore, as seen in FIG. 15 according to the present invention, the challenge information transmitted to Femto Cell 41 as an input for the IMS-AKA authentication is the RAND-aka and AUTN (see step S69 in FIG. 15).

Thus, minimum information required by Femto Cell 41 for the CAVE authentication is mapped to the RAND-aka (128 bits). Information irrelevant to the authentication but required by Femto Cell 41 after success in the authentication is mapped to the AUTN.

Information required by Femto Cell 41 to ensure security between Femto Cell 41 and existing mobile machine 42 during the CAVE authentication in the wireless section is the authentication random number RAND (32 bits), the authentication code AUTHR (18 bits), the SMEKEY (64 bits), and the PLCM (42 bits); a total of 156 bits are required to ensure the security. However, if these parameters are set in the IMS-AKA authentication RAND-aka (128 bits), the remaining bits are short by 28 bits.

Furthermore, the Femto Cell desirably reflects the value of the authentication code AUTHR (18 bits) set in the authentication response signal from actual existing mobile machine 42 with the 2GR-UIM mounted therein, in the response value (RES) for the IMS-AKA authentication to enhance the security (see step S73 in FIG. 15).

Thus, the authentication random number RAND (32 bits) and authentication code AUTHR (18 bits) for the 2GR-UIM-based CAVE authentication are essential for mapping to the RAND-aka (128 bits). The SMEKEY (64 bits) and higher 14 bits of the PLCM are mapped to the remaining 78 bits of the RAND-aka (see FIG. 17a).

28 bits of the PLCM, which correspond to the shortage, are mapped to the AUTN, one of the two parameters RAND-aka and AUTN, which are communicated from P-CSCF 24 to Femto Cell 41 for the authentication challenge (see FIG. 17b).

On the other hand, upon receiving the RAND-aka and the AUTN from P-CSCF 24, Femto Cell 41 extracts not only the authentication random number RAND, which is required for the 2GR-UIM-based CAVE authentication, but also the SMEKEY and the higher 14 bits of the PLCM, from the RAND-aka (see FIG. 18a). Femto Cell 41 further extracts the lower 28 bits of the PLCM, which are contained in the SQN, from the AUTN (see FIG. 18b). Femto Cell 41 then uses the RAND to perform the 2GR-UIM-based CAVE authentication in the wireless section, and then uses the SMEKEY and the PLCM to decipher the ciphered signal from existing mobile machine 42 (see step S73 in FIG. 15).

As described above, according to the second exemplary embodiment of the present invention, HSS/AuC 22, 21 receive, from HLR/AC 12, 11, the authentication random number RAND and authentication code AUTHR, which are required for the 2GR-UIM-based CAVE authentication, and receive the SMEKEY and PLCM, which are required to decipher the ciphered signal received from existing mobile machine 42. HSS/AuC 22, 21 incorporate the RAND (32 bits), the AUTHR (18 bits), the SMEKEY (64 bits), and the higher 14 bits of the PLCM into the RAND-aka (128 bits) to be transmitted to Femto Cell 41, while incorporating the lower 28 bits of the PLCM into the SQN (48 bits), which is contained in the AUTN to be transmitted to Femto Cell 41. Thus, Femto Cell 41 can acquire the RAND, the SMEKEY, and the PLCM. As a result, the Femto Cell can simultaneously control the existing, old CAVE authentication in the wireless section and the IMS-AKA authentication in the MMD network.

Now, a third exemplary embodiment of the present invention will be described. The third exemplary embodiment relates to an authentication scheme for a Femto Cell using a second generation R-UIM card.

IMS security will be described which is required when an existing portable terminal including the second generation R-UIM card is connected to IMS service via the Femto Cell. In addition, a method of mapping security parameters between the second R-UIM-based security and the IMS security is proposed.

The document X00-20070723-036A is referenced which is proposed by a 3GPP2 standards setting body and which describes the IMS security for the second generation portable terminal based on the CAVE authentication. According to the document, the mobile machine including the second generation R-UIM based on the CAVE authentication has an improved ME function (mobile machine control section). Thus, the proposal in the document is expected to achieve IMS security, which is the object of the present invention.

In the present invention, IMS security under the following conditions will be discussed in principal.

1) The function of the portable device including the second generation R-UIM, even the ME function thereof (mobile machine control section), is not improved. That is, the existing portable terminal remains unchanged.

2) The Femto Cell is intended to covert the radio signal for the CDMA2000 line switching network into the SIP signal for the MMD network or vice versa, and transmits the resulting signal.

In addition, a situation is assumed in which the Femto Cell is installed in an IP environment that is not reliably secure, as in a home.

3) The user's A-Key (Authentication Key) and SSD (Shared Secret Data), which are used for calculations for the CAVE authentication and specified for the CDMA2000 line switching network, are not transmitted to the Femto Cell. In this situation, the Femto Cell cannot calculate second generation R-UIM-based security parameters. The SMEKEY and the PLCM are also parameters that cannot be calculated by the Femto Cell. These parameters are used as keys required to cipher and decipher one or both of the radio control signal and radio voice signal specified for the CDMA2000 line switching network. This means that the SMEKEY and the PLCM are not transmitted by the portable terminal though the wireless section. The Femto Cell needs to acquire the SMEKEY and the PLCM from the network side.

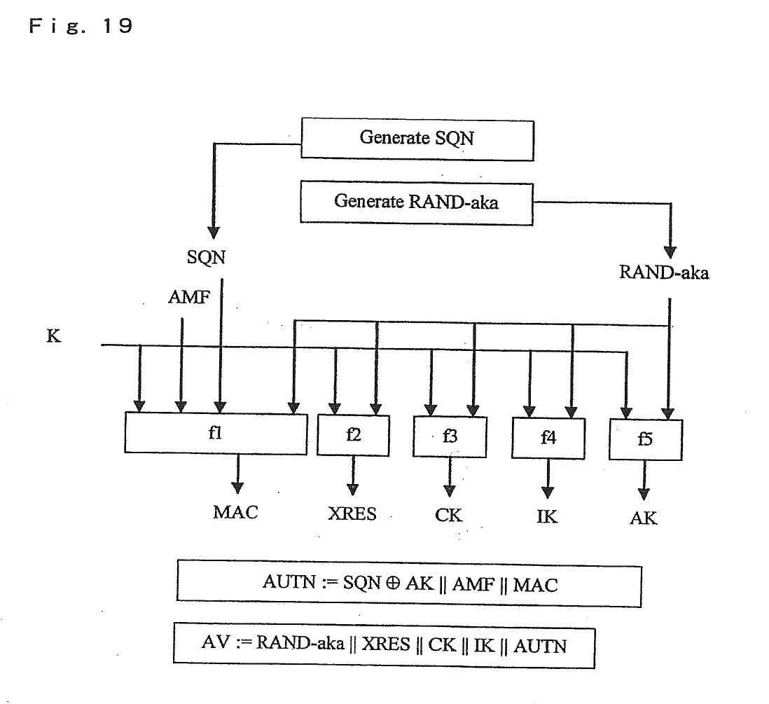

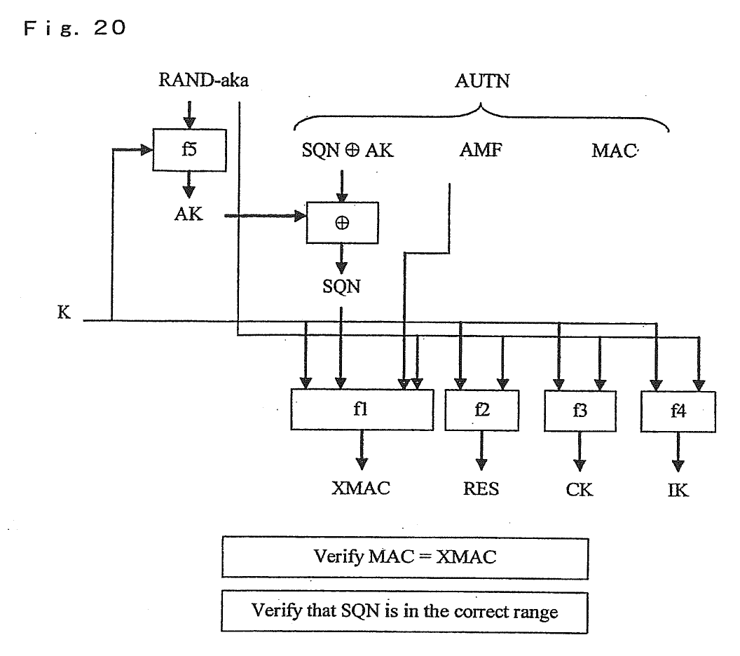

FIG. 19 illustrates a relationship among the authentication parameters in the AuC during AV generation. FIG. 20 illustrates a relationship between a mutual authentication function and a relationship among authentication parameters in an SIM card. These figures are based on written standards formulated by the 3GPP standards body. The written standards are named 3GPP TS33.102.

As seen in FIGS. 19 and 20, the RAND-aka and the K are used as input parameters for all the functions (the functions for the calculation algorithms). Information on the K for IMS security is not provided to the existing portable device including the second generation R-UIM based on the CAVE authentication. In this situation, the K cannot be used for the user authentication. The K may be unused and fixed to 0 for calculations or may be set and calculated by a use method according to the operator's decision. However, in the present invention, the K will not be described in further detail. The other parameter (the remaining parameter different from the K) used as an input parameter for all the functions (the functions for the calculation algorithms), that is, the RAND-aka (128 bits), can be used to transmit required information from the network side to the Femto Cell. The information contains data that is not set or generated by the Femto Cell and is required at least for user authentication for the second generation R-UIM.

The total bit length of the CAVE authentication information in the second generation R-UIM required for the Femto Cell is 156 bits. The respective parameters have the following bit lengths: the RAND, 32 bits; the AUTHR, 18 bits; the SMEKEY, 64 bits; PLCM, 42 bits.

The bit length of the RAND-aka, which is an IMS security parameter, is 128 bits. This is insufficient to set the information required for the Femto Cell in the RAND-aka for transmission. Importantly, at least the RAND and the AUTHR are to be contained in the RAND-aka for transmission to the Femto Cell. This is because the set of the RAND and the AUTHR corresponds to the authentication challenge value and the response value in the second generation R-UIM-based security procedure, and the value of the RAND-aka are treated as one of the input parameters by all the functions for IMS security calculations, so that containment of at least the RAND and the AUTHR in the RAND-aka for transmission to the Femto Cell allows the Femto Cell to obtain the information required to perform the CAVE authentication, and sufficient information for the proxy of the user terminal can be contained in the input to the calculation functions during the IMS-AKA authentication.

Thus, the present invention proposes mapping of the security parameters from the second generation R-UIM basis to the IMS basis.

RAND-aka:=RAND∥AUTHR∥SMEKEY∥PLCM higher 14 bits Proposed Formula (1)

SQN:=PLCM lower 28 bits∥SEQ Proposed Formula (2)

Now, Proposed Formula (2) will be described in brief. Proposed Formula (1) according to the present invention proposes a method of using all the bits of the RAND-aka, one of the two parameters RAND-aka and AUTM of the authentication challenge signal to be transmitted to the user side in the IMS-AKA authentication. On the other hand, as illustrated in FIG. 19, the AUTN is composed of 128 bits as follows.

AUTN:=SQN eor AK∥AMF∥MAC

Among the bits in the AUTN, a MAC (64 bits) is an IMS-AKA authentication parameter calculated and output by both the network side such as the AuC and the user side such as the Femto Cell. Thus, a MAC field cannot be used as the lower 28 bits of the PLCM, which is a CAVE authentication parameter. An AMF (16 bits) may be used according to the operator's use method, as an algorithm version used between the network and the user terminal (in this case, the Femto Cell). Consequently, the AMF desirably remains unchanged.

Thus, the present invention proposes use of a part of the SQN (48 bits in total). In Proposed Formula (2), the remaining part of the SEQ is 20 bits, which can be utilized as the original SQN. Whether or not to use the SEQ for the Femto Cell depends on the operator's policy.

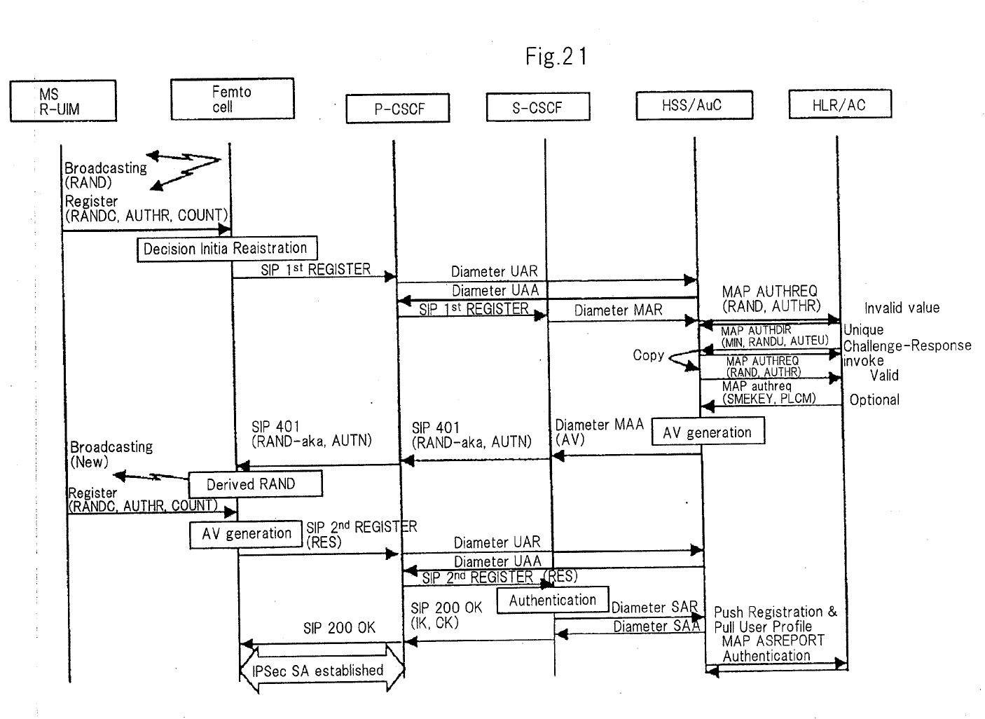

FIG. 21 illustrates an example of a signal sequence according to a third exemplary embodiment of the present invention.

Upon receiving the Diameter MAR signal from the S-CSCF processing the “SIP 1st REGISTER”, the HSS/AuC determines that the user has subscribed to the Femto Cell and transmitted a request through the Femto Cell. The HSS/AuC thus inquires of the related HLR/AC for the second generation R-UIM-based authentication information. Upon receiving a response from the HLR/AC, the HSS/AuC constructs the RAND-aka and the SQN according to proposed rules. The HSS/AuC subsequently uses the RAND-aka and the SQN to generate the AV for the IMS-AKA.

Upon receiving the SIP 404 response signal to the “SIP 1st REGISTER” signal from the P-CSCF, the Femto Cell extracts and obtains the value of the RAND from the RAND-aka, which is contained in a WWW-Authentication header. The Femto Cell then transmits the RAND value to the wireless section as an authentication challenge signal.

Upon receiving the wireless section signal with the authentication response information set therein, the Femto Cell replaces an AUTHR field in the RAND-aka obtained from the P-CSCF with the AUTHR value obtained from the radio signal from the portable terminal. Then, according to proposed rules, the Femto Cell calculates the RES as a response value for the IMS-AKA authentication as well as the IK and the CK.

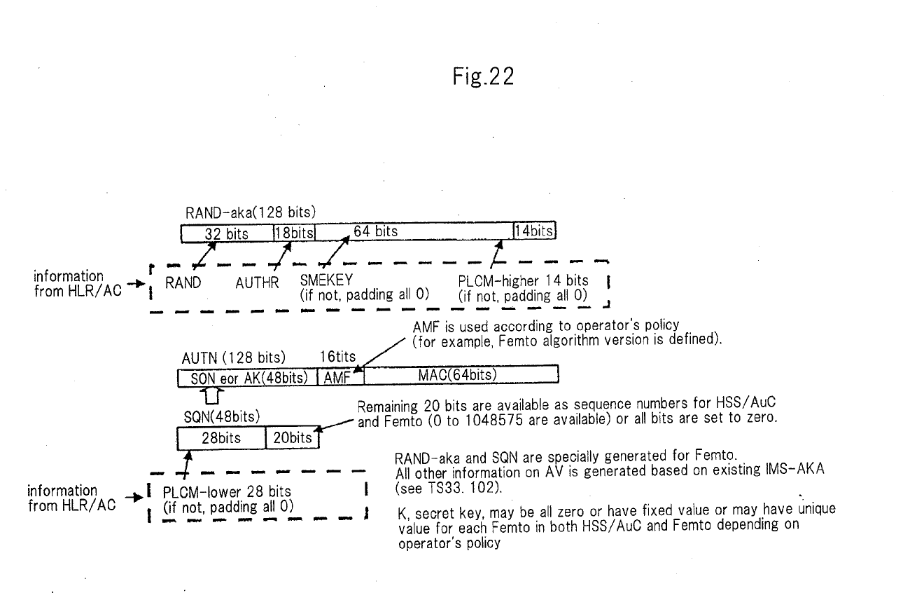

FIG. 22 illustrates the logic of AV generation in the proposed HSS/AuC.

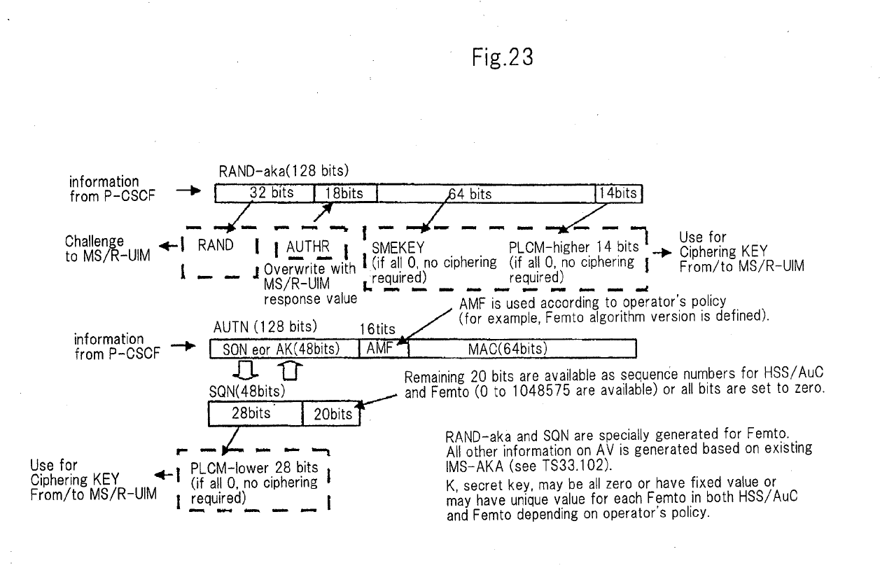

FIG. 23 illustrates AV logic in the proposed Femto Cell.

As described above, according to the third exemplary embodiment of the present invention, when the line switching communication terminal is connected to the MMD network via the small base station, the small base station acquires the information on the ciphering key or the like which is required to authenticate the communication terminal. As a result, the Femto Cell can simultaneously control the existing, old CAVE authentication in the wireless section and the IMS-AKA authentication in the MMD network.

According to the present invention, processing in the authentication information managing server and the small base station is implemented by the above-described dedicated hardware. Alternatively, the processing may be executed by recording a program for implementing the functions of the hardware in a recording medium that can be read by the authentication information managing server and the small base station, and by loading the program recorded in the recording medium into the authentication information managing server and the small base station. Examples of recording medium that can be read by the authentication information managing server and the small base station include portable recording media such as a floppy disc, a magneto-optic disc, a DVD, and a CD, as well as an HDD contained in the authentication information managing server and the small base station. The program recorded in the recording medium is, for example, loaded into a control block, which controls execution of processing similar to that described above.

What is claimed is:

1. A communication system comprising:
first authentication information processing means, provided on a line switching network, for performing first authentication on a communication terminal in the line switching network;
second authentication information processing means, provided on a multimedia communication network, for performing second authentication on a communication terminal in the multimedia communication network;
a small base station provided on a local information communication network to communicate wirelessly with a communication terminal in the local information communication network;
a line switching communication terminal performing communication via the line switching network or the local information communication network;
first authentication processing means, provided in the small base station, for acquiring the first authentication information from the line switching communication terminal and transmitting the first authentication information to the second authentication information processing means;
ciphering key information acquiring means, provided in the second authentication information processing means, for acquiring ciphering key information on the line switching communication terminal from the first authentication information processing means based on the first authentication obtained from the small base station;
authentication information mapping means, provided in the second authentication information processing means, for mapping the ciphering key information to the second authentication information;
mapping information transmitting means, provided in the second authentication information processing means, for transmitting the mapped information to the small base station; and
ciphering key information extracting means, provided in the small base station, for extracting the ciphering key information from the mapped information.

2. The communication system according to claim 1, wherein the line switching network includes:
an existing public base station communicating wirelessly with the line switching communication terminal; and
an existing line switch communicating with the existing public base station using a line switching signal, and
the existing line switch communicates with the first authentication information processing means using an MAP signal.

3. The communication system according to claim 1, wherein the multimedia communication network includes:
a server P-CSCF (Proxy Call Session Control Function) communicating with the small base station using an MMD (Multi Media Domain) SIP (Session Initiation Protocol) signal; and
a server S-CSCF (Serving Call Session Control Function) communicating with the server P-CSCF using an MMD SIP signal, and
the server S-CSCF communicates with the second authentication information processing means using an MMD Diameter signal.

4. The communication system according to claim 1, wherein the first authentication information processing means includes:
a server AC (Authentication Center); and
a server HLR (Home Location Register), and
CAVE (Cellular Authentication and Voice Encryption algorithm) authentication information is processed between the server AC and the server HLR.

5. The communication system according to claim 1, wherein the second authentication information processing means includes:
a server AuC (Authentication Center); and
a server HSS (Home Subscriber Server), and
IMS-AKA (IMS Authentication and Key Agreement) authentication information is processed between the server AuC and the server HSS.

6. The communication system according to claim 5, wherein the server HLR of the first authentication information processing means and the server HSS of the second authentication information processing means communicate with each other using the MAP signal.

7. The communication system according to claim 1, wherein a broadband communication network is connected between the multimedia communication network and the local information communication network.

8. The communication system according to claim 1, wherein the line switching network is a CDMA (Code Division Multiple Access) 2000 line switching network.

9. A communication method in a communication system comprising a first authentication information processing device provided on a line switching network to perform first authentication on a communication terminal in the line switching network, a second authentication information processing device provided on a multimedia communication network to perform second authentication on a communication terminal in the multimedia communication network, a small base station provided on a local information communication network to communicate wirelessly with a communication terminal in the local information communication network, and a line switching communication terminal performing communication via the line switching network or the local information communication network, the method comprising:
allowing the small base station to acquire the first authentication information from the line switching communication terminal and to transmit the first authentication information to the second authentication information processing device;
allowing the second authentication information processing device to acquire ciphering key information on the line switching communication terminal from the first authentication information processing device based on the first authentication obtained from the small base station;
allowing the second authentication information processing device to map the ciphering key information to the second authentication information;
allowing the second authentication information processing device to transmit the mapped information to the small base station; and
allowing the small base station to extract the ciphering key information from the mapped information.

10. The communication method according to claim 9, wherein the line switching network includes:
an existing public base station communicating wirelessly with the line switching communication terminal; and
an existing line switch communicating with the existing public base station using a line switching signal, and
the existing line switch communicates with the first authentication information processing device using an MAP signal.

11. The communication method according to claim 9, wherein the multimedia communication network includes:
a server P-CSCF communicating with the small base station using an MMD SIP signal; and
a server S-CSCF communicating with the server P-CSCF using an MMD SIP signal, and
the server S-CSCF communicates with the second authentication information processing device using an MMD Diameter signal.

12. The communication method according to claim 9, wherein the first authentication information processing device includes:
a server AC; and
a server HLR, and
CAVE authentication information is processed between the server AC and the server HLR.

13. The communication method according to claim 9, wherein the second authentication information processing device includes:
a server AuC; and
a server HSS, and
IMS-AKA authentication information is processed between the server AuC and the server HSS.

14. The communication method according to claim 13, wherein the server HLR of the first authentication information processing device and the server HSS of the second authentication information processing device communicate with each other using the MAP signal.

15. The communication method according to claim 9, wherein a broadband communication network is connected between the multimedia communication network and the local information communication network.

16. The communication method according to claim 9, wherein the line switching network is a CDMA2000 line switching network.

17. An authentication information managing server in a communication system comprising first authentication information processing means, provided on a line switching network, for performing first authentication on a communication terminal in the line switching network, second authentication information processing means, provided on a multimedia communication network, for performing second authentication on a communication terminal in the multimedia communication network, a small base station provided on a local information communication network to communicate wirelessly with a communication terminal in the local information communication network, and a line switching communication terminal performing communication via the line switching network or the local information communication network, the authentication information managing server comprising:
first authentication information processing means and second authentication information processing means, and including:
ciphering key information acquiring means, provided in the second authentication information processing means, for acquiring ciphering key information on the line switching communication terminal from the first authentication information processing means based on the first authentication obtained from the small base station;
authentication information mapping means, provided in the second authentication information processing means, for mapping the ciphering key information to the second authentication information; and
mapping information transmitting means, provided in the second authentication information processing means, for transmitting the mapped information to the small base station,
the small base station extracting the ciphering key information from the mapped information.

18. The authentication information managing server according to claim 17, wherein the first authentication information processing means includes:
a server AC; and
a server HLR, and
CAVE authentication information is processed between the server AC and the server HLR.

19. The authentication information managing server according to claim 17, wherein the second authentication information processing means includes a server AuC and a server HSS, and IMS-AKA authentication information is processed between the server AuC and the server HSS.

20. The authentication information managing server according to claim 19, wherein the server HLR of the first authentication information processing means and the server HSS of the second authentication information processing means communicate with each other using the MAP signal.

21. The authentication information managing server according to claim 17, wherein a broadband communication network is connected between the multimedia communication network and the local information communication network.

22. The authentication information managing server according to claim 17, wherein the line switching network is a CDMA2000 line switching network.

23. A small base station in a communication system comprising first authentication information processing means, provided on a line switching network, for performing first authentication on a communication terminal in the line switching network, second authentication information processing means, provided on a multimedia communication network, for performing second authentication on a communication terminal in the multimedia communication network, a small base station provided on a local information communication network to communicate wirelessly with a communication terminal in the local information communication network, and a line switching communication terminal performing communication via the line switching network or the local information communication network, the small base station comprising:
first authentication processing means for acquiring the first authentication information from the line switching communication terminal and transmitting the first authentication information to the second authentication information processing means; and
ciphering key information extracting means for extracting ciphering key information from mapped information,
the mapped information being obtained by acquiring the ciphering key information on the line switching communication terminal from the first authentication information processing means based on the first authentication received by the second authentication information processing means and by mapping the ciphering key information to the second authentication information.

24. A recording medium in which a program is recorded, the program being used for a communication system comprising a first authentication information processing device provided on a line switching network to perform first authentication on a communication terminal in the line switching network, a second authentication information processing device provided on a multimedia communication network to perform second authentication on a communication terminal in the multimedia communication network, a small base station provided on a local information communication network to communicate wirelessly with a communication terminal in the local information communication network, and a line switching communication terminal performing communication via the line switching network or the local information communication network, the program comprising:
allowing the small base station to acquire the first authentication information from the line switching communication terminal and to transmit the first authentication information to the second authentication information processing device;
allowing the second authentication information processing device to acquire ciphering key information on the line switching communication terminal from the first authentication information processing device based on the first authentication obtained from the small base station;
allowing the second authentication information processing device to map the ciphering key information to the second authentication information;
allowing the second authentication information processing device to transmit the mapped information to the small base station; and
allowing the small base station to extract the ciphering key information from the mapped information.
